(19) United States
(12) Patent Application Publication
(10) Pub. No.: US 2022/0055801 A1
(43) Pub. Date: Feb. 24, 2022

(54) THERMOPLASTIC BAGS COMPRISING LAMINATES HAVING BONDED PROTRUSIONS AND METHODS OF MAKING THE SAME

(71) Applicant: THE GLAD PRODUCTS COMPANY, OAKLAND, CA (US)

(72) Inventors: Shaun T. Broering, Cincinnati, OH (US); Matthew W. Waldron, West Chester, OH (US); Daniel C. Peck, Lebanon, OH (US)

(21) Appl. No.: 17/415,567

(22) PCT Filed: Dec. 10, 2019
(86) PCT No.: PCT/US19/65331

§ 371 Date: Jun. 17, 2021

Related U.S. Application Data
(60) Provisional application No. 62/785,580, filed on Dec. 27, 2018.

(51) Int. Cl. B65D 33/28; B65D 33/00; B65D 33/02; B29C 55/18; B32B 37/10; B32B 27/08; B32B 3/28; B32B 38/00

(52) U.S. Cl. CPC B65D 33/28; B65D 33/007; B65D 33/02; B29C 55/18; B32B 37/10; B32B 27/08; B29L 2031/7128; B32B 38/0012; B32B 2250/02; B32B 2250/24; B32B 2398/20; B32B 2439/46; B32B 3/28

(57) ABSTRACT

Thermoplastic bags include laminates with bonded protrusions. More specifically, one or more implementations include a first thermoplastic film with a plurality of raised rib-like elements extending in a direction perpendicular to a main surface of the first thermoplastic film and second thermoplastic film bonded to the protrusions (e.g., raised rib-like elements or troughs between the raised rib-like elements) of the first thermoplastic film. By bonding a second thermoplastic film to the protrusions of the first thermoplastic film, the resulting laminate has an increased effective gauge or loft. In one or more implementations the second thermoplastic film is a flat film. In alternative implementations, the second thermoplastic film comprises a plurality of raised rib-like elements extending in a direction perpendicular to a main surface of the second thermoplastic film and protrusions of the first thermoplastic film are bonded to protrusions of the second thermoplastic film.

### CROSS-REFERENCE TO RELATED APPLICATION

This application is a 35 U.S.C. 371 national phase of PCT International Application No. US19/65331, filed on Dec. 10, 2019, which claims the benefit of and priority to U.S. Provisional Application No. 62/785,580, filed Dec. 27, 2018, and entitled: THERMOPLASTIC BAGS COMPRISING LAMINATES HAVING BONDED PROTRUSIONS AND METHODS OF MAKING THE SAME. The contents of the above-referenced application are hereby incorporated by reference in their entirety.

### BACKGROUND

### 1. Technological Field

The present application relates generally to bags formed from thermoplastic films. Specifically, the invention relates to thermoplastic bags with increased effective gauge and to methods of manufacturing thermoplastic bags to increase the effective gauge thereof.

### 2. Background

Thermoplastic films are a common component in various commercial and consumer products. For example, grocery bags, trash bags, sacks, and packaging materials are products that are commonly made from thermoplastic films. Additionally, feminine hygiene products, baby diapers, adult incontinence products, and many other products include thermoplastic films to one extent or another.

The cost to produce products including thermoplastic film is directly related to the cost of the thermoplastic film. Recently the cost of thermoplastic materials has risen. In response, many manufacturers attempt to control manufacturing costs by decreasing the amount of thermoplastic material in a given product.

One way manufacturers may attempt to reduce production costs is to use thinner films or stretch the thermoplastic films, thereby increasing surface area and reducing the amount of thermoplastic film needed to produce a product of a given size. Common directions of stretching include “machine direction” and “transverse direction” stretching. As used herein, the term “machine direction” or “MD” refers to the direction along the length of the film, or in other words, the direction of the film as the film is formed during extrusion and/or coating. As used herein, the term “transverse direction” or “TD” refers to the direction across the film or perpendicular to the machine direction.

Common ways of stretching film in the machine direction include machine direction orientation (“MDO”) and incremental stretching. MDO involves stretching the film between pairs of smooth rollers. Commonly, MDO involves running a film through the nips of sequential pairs of smooth rollers. The first pair of rollers rotates at a speed less than that of the second pair of rollers. The difference in speed of rotation of the pairs of rollers can cause the film between the pairs of rollers to stretch. The ratio of the roller speeds will roughly determine the amount that the film is stretched. MDO stretches the film continuously in the machine direction and is often used to create an oriented film.

Incremental stretching of thermoplastic film, on the other hand, typically involves running the film between grooved or toothed rollers. The grooves or teeth on the rollers intermesh and stretch the film as the film passes between the rollers. Incremental stretching can stretch a film in many small increments that are evenly spaced across the film. The depth at which the intermeshing teeth engage can control the degree of stretching.

Unfortunately, stretched or otherwise thinner thermoplastic films can have undesirable properties. For example, thinner thermoplastic films are typically more transparent or translucent. Additionally, consumers commonly associate thinner films with weakness. Such consumers may feel that they are receiving less value for their money when purchasing products with thinner films; and thus, may be dissuaded to purchase thinner thermoplastic films. As such, manufacturers may be dissuaded to stretch a film or use thinner films despite the potential material savings.

Accordingly, there are a number of considerations to be made in thermoplastic bags and manufacturing methods.

### BRIEF SUMMARY

One or more implementations described herein solve one or more problems in the art with apparatus and methods for creating thermoplastic bags with laminates having bonded protrusions. In particular, one or more implementations include a bag including a laminate of a first thermoplastic film and a second thermoplastic film that provides one or more areas or features of the bag with an increased effective gauge. More specifically, one or more implementations include a first thermoplastic film with a plurality of protrusions and a second thermoplastic film bonded to the protrusions of the first thermoplastic film. By bonding a second thermoplastic film to the protrusions of the first thermoplastic film, the resulting laminate has an increased effective gauge or loft.

For example, an implementation of a thermoplastic bag comprises first and second sidewalls of a thermoplastic film material. The thermoplastic bag also includes a bottom edge connecting the first and second sidewalls. Furthermore, the thermoplastic bag includes a closure mechanism for selectively closing an opening of the thermoplastic bag. One or more portions of the thermoplastic bag comprise a laminate with bonded protrusions. The laminate with bonded protrusions comprises a first thermoplastic film having a strainable network formed from a plurality of protrusions. Protrusions of the strainable network of the first thermoplastic film are laminated to a second thermoplastic film. The plurality of protrusions comprise raised rib-like elements connected to troughs by stretched, transition regions. The stretched, transition regions are thinner than the rib-like elements and the troughs.

Additionally, another implementation of thermoplastic bag comprise first and second sidewalls a bottom edge connecting the first and second sidewalls, and a closure mechanism for selectively closing an opening of the thermoplastic bag. The thermoplastic bag further comprises a laminate with bonded protrusions. The laminate with bonded protrusions comprises a first thermoplastic film incrementally bonded to a second thermoplastic film. A first strainable network is formed in the first thermoplastic film. The first stainable network comprises a first plurality of protrusions. A second strainable network is formed in the second thermoplastic film. The second strainable network comprises a second plurality of protrusions. The second strainable network is configured and oriented as a mirrored version of the first strainable network. Additionally, protrusions of the first plurality of protrusions are bonded to protrusions of the second plurality of protrusions. The first and second plurality of protrusions of the first and second strainable networks comprise raised rib-like elements connected to troughs by stretched, transition regions. The stretched, transition regions are thinner than the rib-like elements and the troughs. The protrusions of the first and second plurality of protrusions bonded to each other comprise one of the rib-like elements or the troughs. The other of the rib-like elements or the troughs are separated from each other by a distance that provides the thermoplastic bag with an increased effective gauge.

In addition to the forgoing, a method of forming thermoplastic bags with laminates having bonded protrusions involves creating a first strainable network of protrusions in a first thermoplastic film by advancing the first thermoplastic film through a first pair of patterning rolls. The method further involves creating a second strainable network of protrusions in a second thermoplastic film by advancing the second thermoplastic film through a second pair of patterning rolls. The method additionally involves bonding protrusions of the first strainable network to protrusions of the second strainable network by advancing the first and second thermoplastic films together through a first patterning roller of the first pair of patterning rolls and a second patterning roller of the second pair of patterning rolls. Also, the method involves forming the bonded first and second thermoplastic films into a bag.

Additional features and advantages of exemplary embodiments of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIGS. 1A-1C show partial side cross-sectional views of thermoplastic films having varying numbers of sublayers according to one or more implementations of the present disclosure;

FIG. 2 shows a perspective view of a pair of SELF'ing rollers according to one or more implementations of the present disclosure;

FIG. 3 shows a perspective view of a SELF'ed film according to one or more implementations of the present disclosure;

FIG. 4A illustrates a front view of a thermoplastic bag comprising one or more laminates having bonded protrusions according to an implementation of the present disclosure;

FIG. 4B illustrates is a cross-sectional view of the thermoplastic bag of FIG. 4A taken along the line 4B-4B illustrating one implementation of a laminate having bonded protrusions according to an implementation of the present disclosure;

FIG. 4C illustrates is a cross-sectional view of the thermoplastic bag of FIG. 4A taken along the line 4B-4B illustrating another implementation of a laminate having bonded protrusions according to an implementation of the present disclosure;

FIG. 4D illustrates is a cross-sectional view of the thermoplastic bag of FIG. 4A taken along the line 4B-4B illustrating yet another implementation of a laminate having bonded protrusions according to an implementation of the present disclosure;

FIG. 4E illustrates is a cross-sectional view of the thermoplastic bag of FIG. 4A taken along the line 4B-4B illustrating still another implementation of a laminate having bonded protrusions according to an implementation of the present disclosure;

FIG. 5A illustrates is a front side view of a thermoplastic bag in which tops of the sides walls include laminates having bonded protrusions according to an implementation of the present disclosure;

FIG. 5B illustrates is a cross-sectional view of the side wall of the thermoplastic bag of FIG. 5A taken along the line 5B-5B illustrating one implementation of a laminate having bonded protrusions according to an implementation of the present disclosure;

FIG. 6A illustrates is a front side view of a thermoplastic bag in which bottoms of the sides walls include laminates having bonded protrusions according to an implementation of the present disclosure;

FIG. 6B illustrates is a cross-sectional view of the side wall of the thermoplastic bag of FIG. 6A taken along the line 6B-6B illustrating one implementation of a laminate having bonded protrusions according to an implementation of the present disclosure;

FIG. 7 illustrates is a cross-sectional view of a thermoplastic bag illustrating locations reinforced with laminates having bonded protrusions according to an implementation of the present disclosure;

FIG. 8 illustrates is a cross-sectional view of another thermoplastic bag illustrating locations reinforced with laminates having bonded protrusions according to an implementation of the present disclosure;

FIG. 9 illustrates a schematic diagram of a process of forming a laminate having bonded protrusions with offset main portions according to an implementation of the present disclosure;

FIG. 10 illustrates a schematic diagram of a process a process of forming a laminate having bonded protrusions with adjacent main portions according to an implementation of the present disclosure; and

FIG. 11 illustrates a schematic diagram of a process of manufacturing thermoplastic bags having laminates with bonded protrusions according to an implementation of the present disclosure.

### DETAILED DESCRIPTION

One or more implementations of the present disclosure include apparatus and methods for creating thermoplastic bags with laminates having bonded protrusions. In particular, one or more implementations include a bag including a laminate of a first thermoplastic film and a second thermoplastic film that provides one or more areas or features of the bag with an increased effective gauge. More specifically, one or more implementations include a first thermoplastic film with a plurality of raised rib-like elements extending in a direction perpendicular to a main surface of the first thermoplastic film and second thermoplastic film bonded to the protrusions (e.g., raised rib-like elements or troughs between the raised rib-like elements) of the first thermoplastic film. By bonding a second thermoplastic film to the protrusions of the first thermoplastic film, the resulting laminate has an increased effective gauge or loft. In one or more implementations the second thermoplastic film is a flat film. In alternative implementations, the second thermoplastic film comprises a plurality of raised rib-like elements extending in a direction perpendicular to a main surface of the second thermoplastic film and protrusions of the first thermoplastic film are bonded to protrusions of the second thermoplastic film.

As mentioned above, one or more implementations of a thermoplastic bag include laminates having bonded protrusions. For example, in one or more implementations, the entire sidewalls of a thermoplastic bag, or a substantial portion thereof, include laminates having bonded protrusions. In alternative implementations only portions of the thermoplastic bag comprise laminates having bonded protrusions. For instance, one or more of the drawstring, top of the thermoplastic bag, or bottom of the thermoplastic bag comprises laminates having bonded protrusions while other portions of the thermoplastic bag are devoid of laminates having bonded protrusions.

As mentioned above, one or more implementations can provide thermoplastic bags with increased effective gauge created by bonding protrusions of a thermoplastic film to another thermoplastic film. The increased effective gauge can connote strength to a consumer and provide a desirable look and feel to the bag, or portions thereof

Furthermore, one or more implementations allow for tailoring (e.g., increasing) of the effective gauge of a thermoplastic bag independent of the basis weight (amount of raw material) of the thermoplastic bag. In other words, one or more implementations. Thus, one or more implementations can provide a thermoplastic bag with increased effective gauge despite a reduction, or lack of increase, of thermoplastic material used to form the thermoplastic bag. As such, one or more implementations can reduce the material needed to produce a product while maintaining or increasing the effective gauge of the thermoplastic bag.

Additionally, consumers may associate thinner films/bags (e.g., films/bags with decreased basis weight) with decreased strength. Indeed, consumers may feel that they are receiving less value for their money when purchasing thermoplastic bags with thinner gauges. One will appreciate in light of the disclosure herein that a consumer may not readily detect that one or more thermoplastic bags including laminates having bonded protrusions has a reduced basis weight. In particular, by increasing the effective gauge, the consumer may perceive the bag as being thicker and/or having increased strength.

More particularly, laminates with bonded protrusions according to one or more implementations described herein can have increased bending stiffness. In particular, the bending stiffness of laminates with bonded protrusions can be 50-10,000 percent greater than a flat film with the same basis weight. The increased bending stiffness of laminates with bonded protrusions can deliver a tactile performance that a consumer is used to experiencing in films with 1.25 to 4.5 times the basis weight.

In addition to the foregoing, one or more implementations provide thermoplastic bags that consumers can associate with improved properties. For example, the regions with bonded protrusions can indicate that those regions have undergone a transformation to impart a desirable characteristic to that region (e.g., increased strength or thicker feel). Thus, the regions with bonded protrusions can serve to notify a consumer that the thermoplastic film has been processed to improve the film.

In one or more implementations, the thermoplastic films in the thermoplastic bags comprise a strainable network created using a SELF'ing (structural elastic-like film) process. The strainable network can comprise a plurality of raised rib-like elements extending in a direction perpendicular to a main surface of the thermoplastic film. The plurality of rib-like elements can be separated by troughs. The raised rib-like elements and troughs are surrounded by a plurality of web areas or main portions of the film. The stainable network provides the thermoplastic film with an elastic-like behavior. In particular, when subjected to an applied load, the raised rib-like elements can initially undergo a substantially geometric deformation before undergoing substantial molecular-level deformation when subjected to an applied load. On the other hand, the web areas can undergo a substantially molecular-level and geometric deformation in response to the applied strain. U.S. Pat. Nos. 5,518,801 and 5,650,214 each disclose processes for forming strainable networks using SELF'ing processes. The contents of each of the aforementioned patents are incorporated in their entirety by reference herein.

In addition to the foregoing benefits, laminates with bonded protrusions provide improvements over unformed, single layer bags. Such laminates with bonded protrusions can be designed with greater resistance to bending, improved resilience to compression, and can be patterned for directionally oriented responses to tensile loads. Also, laminates with bonded protrusions can use their layered structure to provide better aesthetics; for example, multiple layers of the laminates with bonded protrusions can diffract and diffuse light more completely, resulting in increased opacity. Further, laminates with bonded protrusions can use their formations to provide enhanced structural properties; for example, laminates with varying formations can distribute and absorb concentrated forces more effectively, resulting in improved puncture resistance. In addition, such laminates with bonded protrusions can be configured with thicker portions and designed patterns, which are appealing to consumers.

Furthermore, in various implementations, the laminates disclosed herein can exhibit directionally variable bending stiffness. The bonds can act like beams in their direction of orientation, providing directional strengthening of the connected films. The unbonded regions may or may not act like hinges, depending on their configuration within the laminate. As an example, a laminate may have a first direction (parallel with the overall planar orientation of the laminate) having a lowest bending stiffness for the laminate, and a second direction (also parallel with the overall planar orientation of the laminate), which differs from the first direction (e.g. is perpendicular to the first direction), having a highest bending stiffness for the laminate, wherein the highest bending stiffness is 50-10,000% greater than the lowest bending stiffness, or any integer value between 50% and 5,000%, or any range formed by any of these values, such as 50-2,000%, 75-1,000%, 100-500%, etc.

### Film Materials

As an initial matter, the thermoplastic material of the films of one or more implementations of the present disclosure may include thermoplastic polyolefins, including polyethylene and copolymers thereof and polypropylene and copolymers thereof. The olefin-based polymers may include ethylene or propylene based polymers such as polyethylene, polypropylene, and copolymers such as ethylene vinyl acetate (EVA), ethylene methyl acrylate (EMA) and ethylene acrylic acid (EAA), or blends of such polyolefins.

Other examples of polymers suitable for use as films in accordance with the present disclosure may include elastomeric polymers. Suitable elastomeric polymers may also be biodegradable or environmentally degradable. Suitable elastomeric polymers for the film include poly(ethylene-butene), poly(ethylene-hexene), poly(ethylene-octene), poly(ethylene-propylene), poly(styrene-butadiene-styrene), poly(styrene-isoprene-styrene), poly(styrene-ethylene-butylene-styrene), poly(ester-ether), poly(ether-amide), poly(ethylene-vinylacetate), poly(ethylene-methylacrylate), poly(ethylene-acrylic acid), oriented poly(ethylene-terephthalate), poly(ethylene-butylacrylate), polyurethane, poly(ethylene-propylene-diene), ethylene-propylene rubber, nylon, etc.

Some of the examples and description herein below refer to films formed from linear low-density polyethylene. The term “linear low density polyethylene” (LLDPE) as used herein is defined to mean a copolymer of ethylene and a minor amount of an olefin containing 4 to 10 carbon atoms, having a density of from about 0.910 to about 0.930, and a melt index (MI) of from about 0.5 to about 10. For example, some examples herein use an octene comonomer, solution phase LLDPE (MI=1.1; ρ=0.920). Additionally, other examples use a gas phase LLDPE, which is a hexene gas phase LLDPE formulated with slip/AB (MI=1.0; ρ=0.920). Still further examples use a gas phase LLDPE, which is a hexene gas phase LLDPE formulated with slip/AB (MI=1.0; ρ=0.926). One will appreciate that the present disclosure is not limited to LLDPE, and can include “high density polyethylene” (HDPE), “low density polyethylene” (LDPE), and “very low density polyethylene” (VLDPE). Indeed, films made from any of the previously mentioned thermoplastic materials or combinations thereof can be suitable for use with the present disclosure.

Some implementations of the present disclosure may include any flexible or pliable thermoplastic material that may be formed or drawn into a web or film. Furthermore, the thermoplastic materials may include a single layer or multiple layers. The thermoplastic material may be opaque, transparent, translucent, or tinted. Furthermore, the thermoplastic material may be gas permeable or impermeable.

As used herein, the term “flexible” refers to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and structures that are flexible, therefore, may be altered in shape and structure to accommodate external forces and to conform to the shape of objects brought into contact with them without losing their integrity. In accordance with further prior art materials, web materials are provided which exhibit an “elastic-like” behavior in the direction of applied strain without the use of added traditional elastic materials. As used herein, the term “elastic-like” describes the behavior of web materials which when subjected to an applied strain, the web materials extend in the direction of applied strain, and when the applied strain is released the web materials return, to a degree, to their pre-strained condition.

As used herein, the term “substantially,” in reference to a given parameter, property, or condition, means to a degree that one of ordinary skill in the art would understand that the given parameter, property, or condition is met within a degree of variance, such as within acceptable manufacturing tolerances. By way of example, depending on the particular parameter, property, or condition that is substantially met, the parameter, property, or condition may be at least 70.0% met, at least 80.0%, at least 90% met, at least 95.0% met, at least 99.0% met, or even at least 99.9% met.

Additional additives that may be included in one or more implementations include slip agents, anti-block agents, voiding agents, or tackifiers. Additionally, one or more implementations of the present disclosure include films that are devoid of voiding agents. Some examples of inorganic voiding agents, which may further provide odor control, include the following but are not limited to: calcium carbonate, magnesium carbonate, barium carbonate, calcium sulfate, magnesium sulfate, barium sulfate, calcium oxide, magnesium oxide, titanium oxide, zinc oxide, aluminum hydroxide, magnesium hydroxide, talc, clay, silica, alumina, mica, glass powder, starch, charcoal, zeolites, any combination thereof, etc. Organic voiding agents, polymers that are immiscible in the major polymer matrix, can also be used. For instance, polystyrene can be used as a voiding agent in polyethylene and polypropylene films.

One of ordinary skill in the art will appreciate in view of the present disclosure that manufacturers may form the films or webs to be used with the present disclosure using a wide variety of techniques. For example, a manufacturer can form precursor mix of the thermoplastic material and one or more additives. The manufacturer can then form the film(s) from the precursor mix using conventional flat or cast extrusion or co-extrusion to produce monolayer, bilayer, or multilayer films. Alternatively, a manufacturer can form the films using suitable processes, such as, a blown film process to produce monolayer, bilayer, or multilayer films. If desired for a given end use, the manufacturer can orient the films by trapped bubble, tenterframe, or other suitable process. Additionally, the manufacturer can optionally anneal the films thereafter.

An optional part of the film-making process is a procedure known as “orientation.” The orientation of a polymer is a reference to its molecular organization, i.e., the orientation of molecules relative to each other. Similarly, the process of orientation is the process by which directionality (orientation) is imposed upon the polymeric arrangements in the film. The process of orientation is employed to impart desirable properties to films, including making cast films tougher (higher tensile properties). Depending on whether the film is made by casting as a flat film or by blowing as a tubular film, the orientation process can require different procedures. This is related to the different physical characteristics possessed by films made by conventional film-making processes (e.g., casting and blowing). Generally, blown films tend to have greater stiffness and toughness. By contrast, cast films usually have the advantages of greater film clarity and uniformity of thickness and flatness, generally permitting use of a wider range of polymers and producing a higher quality film.

When a film has been stretched in a single direction (mono-axial orientation), the resulting film can exhibit strength and stiffness along the direction of stretch, but can be weak in the other direction, i.e., across the stretch, often splitting when flexed or pulled. To overcome this limitation, two-way or biaxial orientation can be employed to more evenly distribute the strength qualities of the film in two directions. Most biaxial orientation processes use apparatus that stretches the film sequentially, first in one direction and then in the other.

In one or more implementations, the films of the present disclosure are blown film, or cast film. Both a blown film and a cast film can be formed by extrusion. The extruder used can be a conventional one using a die, which will provide the desired gauge. Some useful extruders are described in U.S. Pat. Nos. 4,814,135; 4,857,600; 5,076,988; 5,153,382; each of which are incorporated herein by reference in their entirety. Examples of various extruders, which can be used in producing the films to be used with the present disclosure, can be a single screw type modified with a blown film die, an air ring, and continuous take off equipment.

In one or more implementations, a manufacturer can use multiple extruders to supply different melt streams, which a feed block can order into different channels of a multi-channel die. The multiple extruders can allow a manufacturer to form a film with layers having different compositions. Such multi-layer film may later be provided with a raised rib-like elements and bonded to other films to provide one or more the benefits of the present disclosure.

In a blown film process, the die can be an upright cylinder with a circular opening. Rollers can pull molten thermoplastic material upward away from the die. An air-ring can cool the film as the film travels upwards. An air outlet can force compressed air into the center of the extruded circular profile, creating a bubble. The air can expand the extruded circular cross section by a multiple of the die diameter. This ratio is called the “blow-up ratio.” When using a blown film process, the manufacturer can collapse the film to double the plies of the film. Alternatively, the manufacturer can cut and fold the film, or cut and leave the film unfolded.

In any event, in one or more implementations, the extrusion process can orient the polymer chains of the blown film. The “orientation” of a polymer is a reference to its molecular organization, i.e., the orientation of molecules or polymer chains relative to each other. In particular, the extrusion process can cause the polymer chains of the blown film to be predominantly oriented in the machine direction. The orientation of the polymer chains can result in an increased strength in the direction of the orientation. As used herein predominately oriented in a particular direction means that the polymer chains are more oriented in the particular direction than another direction. One will appreciate, however, that a film that is predominately oriented in a particular direction can still include polymer chains oriented in directions other than the particular direction. Thus, in one or more implementations the initial or starting films (films before being stretched or bonded or laminated in accordance with the principles described herein) can comprise a blown film that is predominately oriented in the machine direction.

The process of blowing up the tubular stock or bubble can further orient the polymer chains of the blown film. In particular, the blow-up process can cause the polymer chains of the blown film to be bi-axially oriented. Despite being bi-axially oriented, in one or more implementations the polymer chains of the blown film are predominantly oriented in the machine direction (i.e., oriented more in the machine direction than the transverse direction).

The films of one or more implementations of the present disclosure can have a starting gauge between about 0.1 mils to about 20 mils, suitably from about 0.2 mils to about 4 mils, suitably in the range of about 0.3 mils to about 2 mils, suitably from about 0.6 mils to about 1.25 mils, suitably from about 0.9 mils to about 1.1 mils, suitably from about 0.3 mils to about 0.7 mils, and suitably from about 0.4 mils and about 0.6 mils. Additionally, the starting gauge of films of one or more implementations of the present disclosure may not be uniform. Thus, the starting gauge of films of one or more implementations of the present disclosure may vary along the length and/or width of the film.

One or more layers of the films described herein can comprise any flexible or pliable material comprising a thermoplastic material and that can be formed or drawn into a web or film. As described above, the film includes a plurality of layers of thermoplastic films. Each individual film layer may itself include a single layer or multiple layers. In other words, the individual layers of the multi-layer film may each themselves comprise a plurality of laminated layers. Such layers may be significantly more tightly bonded together than the bonding provided by the purposely weak discontinuous bonding in the finished multi-layer film. Both tight and relatively weak lamination can be accomplished by joining layers by mechanical pressure, joining layers with adhesives, joining with heat and pressure, spread coating, extrusion coating, ultrasonic bonding, static bonding, cohesive bonding and combinations thereof. Adjacent sub-layers of an individual layer may be coextruded. Co-extrusion results in tight bonding so that the bond strength is greater than the tear resistance of the resulting laminate (i.e., rather than allowing adjacent layers to be peeled apart through breakage of the lamination bonds, the film will tear).

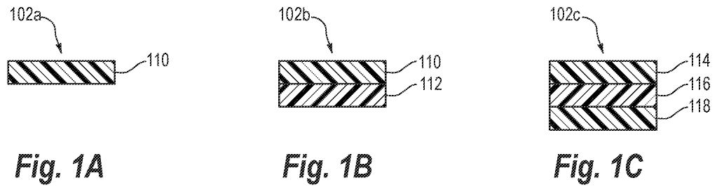

Each film in a laminates having bonded protrusions can may include a single film formed from one, two, three, or more layers of thermoplastic material. FIGS. 1A-1C are partial cross-sectional views of multi-layer films which can be used in a laminate having bonded protrusions. Such films can then be used to form products, such as a thermoplastic bag. In some implementations, the film may include a single layer film 102a, as shown in FIG. 1A, comprising a single layer 110. In other embodiments, the film can comprise a two-layer film 102b as shown in FIG. 1B, including a first layer 110 and a second layer 112. The first and second layers 110, 112 can be coextruded. In such implementations, the first and second layers 110, 112 may optionally include different grades of thermoplastic material and/or include different additives, including polymer additives. In yet other implementations, a film be a tri-layer film 102c, as shown in FIG. 1C, including a first layer 110, a second layer 112, and a third layer 114. In yet other implementations, a film may include more than three layers. The tri-layer film 102c can include an A:B:C configuration in which all three layers vary in one or more of gauge, composition, color, transparency, or other properties. Alternatively, the tri-layer film 102c can comprise an A:A:B structure or A:B:A structure in which two layers have the same composition, color, transparency, or other properties. In an A:A:B structure or A:B:A structure the A layers can comprise the same gauge or differing gauge. For example, in an A:A:B structure or A:B:A structure the film layers can comprise layer ratios of 20:20:60, 40:40:20, 15:70:15, 33:34:33, 20:60:20, 40:20:40, or other ratios.

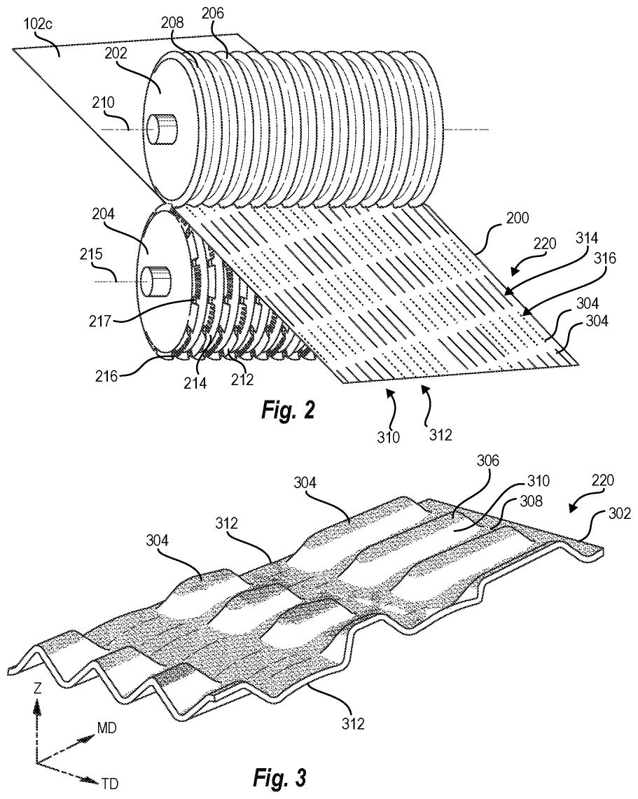

FIG. 2 shows a pair of SELF'ing intermeshing rollers 202, 204 (e.g., a first SELF'ing intermeshing roller 202 and a second SELF'ing intermeshing roller 204) for creating strainable networks with raised rib-like elements. As shown in FIG. 2, the first SELF'ing intermeshing roller 202 may include a plurality of ridges 206 and grooves 208 extending generally radially outward in a direction orthogonal to an axis of rotation 210. As a result, the first SELF'ing intermeshing roller 202 can be similar to a transverse direction (“TD”) intermeshing roller such as the TD intermeshing rollers described in U.S. Pat. No. 9,186,862 to Broering et al., the disclosure of which is incorporated in its entirety by reference herein. The second SELF'ing intermeshing roller 204 can also include a plurality of ridges 212 and grooves 214 extending generally radially outward in a direction orthogonal to an axis of rotation 215. As shown in FIG. 2, in some embodiments, the ridges 216 of the second SELF'ing intermeshing roller 204 may include a plurality of notches 217 that define a plurality of spaced teeth 216.

As shown by FIG. 2, passing a film, such as film 102c, through the SELF'ing intermeshing rollers 202, 204 can produce a thermoplastic film 200 with one or more strainable networks formed by a structural elastic like process in which the strainable networks have a pattern in the form of a checkerboard pattern. As used herein, the term “strainable network” refers to an interconnected and interrelated group of regions which are able to be extended to some useful degree in a predetermined direction providing the web material with an elastic-like behavior in response to an applied and subsequently released elongation.

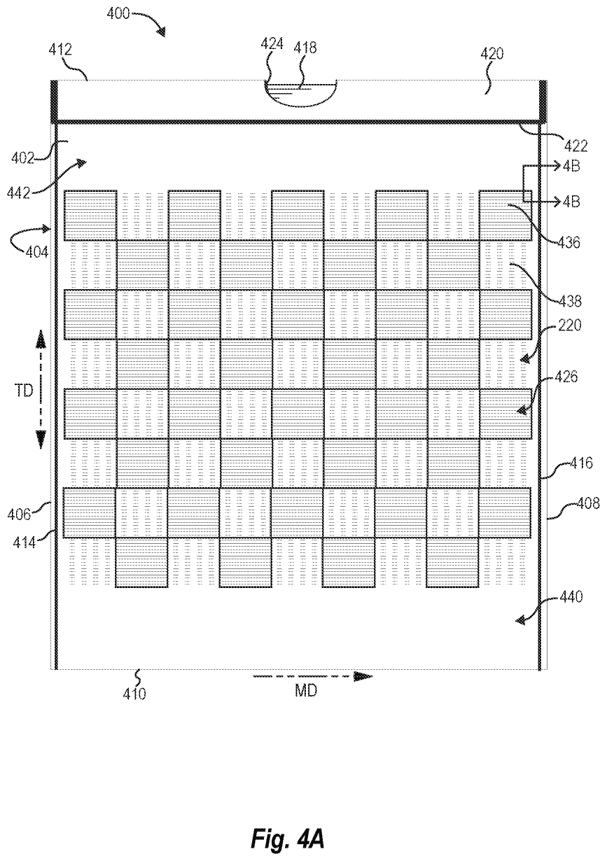

FIG. 3 shows a portion of the thermoplastic film 200 with the checkerboard pattern 220. Referring to FIGS. 2 and 3 together, as film (e.g., film 102c) passes through the SELF'ing intermeshing rollers 202, 204, the teeth 216 can press a portion of the film out of plane defined by the film to cause permanent deformation of a portion of the film in the Z-direction. For example, the teeth 216 can intermittently stretch a portion of the film 102c in the Z-direction. The portions of the film 102c that pass between the notched regions 217 of the teeth 216 will remain substantially unformed in the Z-direction. As a result of the foregoing, the thermoplastic film 200 with the complex stretch pattern 220 includes a plurality of isolated deformed, raised, rib-like elements 304 and at least one un-deformed portion (or web area) 302 (e.g., a relatively flat region). As will be understood by one of ordinary skill in the art, the length and width of the rib-like elements 304 depend on the length and width of teeth 216 and the speed and the depth of engagement of the intermeshing rollers 202, 204. The rib-like elements 304 and the un-deformed web areas 302 form a strainable network.

As shown in FIG. 3, the strainable network of the film 200 can include first thicker regions 306, second thicker regions 308, and stretched, thinner transitional regions 310 connecting the first and second thicker regions 306, 308. The first thicker regions 306 and the stretched, thinner regions 310 can form the raised rib-like elements 304 of the strainable network. The raised rib-like elements 304 can be separated by troughs 312. The raised rib-like elements 304 and the troughs 312, respectively are the protrusions that can be bonded to another film or other protrusions as described in greater detail below. In particular, in one implementation raised rib-like elements 304 of a film are bonded to another film to form a laminate with bonded protrusions. In another implementation, troughs 312 are bonded to another film to form a laminate with bonded protrusions.

In one or more embodiments, the first thicker regions 306 are the portions of the film with the greatest displacement in the Z-direction. In one or more embodiments, because the film is displaced in the Z-direction by pushing the rib-like elements 304 in a direction perpendicular to a main surface of the thermoplastic film (thereby stretching the regions 310 upward) a total length and width of the film does not substantially change when the film is subjected to the SELF'ing process of one or more implementations. In other words, the film 102c (film prior to undergoing the SELF'ing process) can have substantially the same width and length as the film 200 resulting from the SELF'ing process.

As shown by FIG. 3, the rib-like elements can have a major axis and a minor axis (i.e., the rib-like elements are elongated such that they are longer than they are wide). As shown by FIGS. 2 and 3, in one or more embodiments, the major axes of the rib-like elements are parallel to the machine direction (i.e., the direction in which the film was extruded). In alternative embodiments, the major axes of the rib-like elements are parallel to the transverse direction. In still further embodiments, the major axes of the rib-like elements are oriented at an angle between 1 and 89 degrees relative to the machine direction. For example, in one or more embodiments, the major axes of the rib-like elements are at a 45-degree angle to the machine direction. In one or more embodiments, the major axes are linear (i.e., in a straight line) in alternative embodiments the major axes are curved or have otherwise non-linear shapes.

The rib-like elements 304 can undergo a substantially “geometric deformation” prior to a “molecular-level deformation.” As used herein, the term “molecular-level deformation” refers to deformation, which occurs on a molecular level and is not discernible to the normal naked eye. That is, even though one may be able to discern the effect of molecular-level deformation, e.g., elongation or tearing of the film, one is not able to discern the deformation, which allows or causes it to happen. This is in contrast to the term “geometric deformation,” which refers to deformations that are generally discernible to the normal naked eye when a SELF'ed film or articles embodying the such a film are subjected to an applied load or force. Types of geometric deformation include, but are not limited to bending, unfolding, and rotating.

Thus, upon application of a force, the raised rib-like elements 304 can undergo geometric deformation before undergoing molecular-level deformation. For example, a strain applied to the film 200 in a perpendicular to the major axes of the rib-like elements 304 can pull the raised rib-like elements 304 back into plane with the web areas 302 prior to any molecular-level deformation of the raised rib-like elements 304. Geometric deformation can result in significantly less resistive forces to an applied strain than that exhibited by molecular-level deformation.

As shown by FIGS. 2 and 3, groups of raised rib-like elements 304 can be arranged in different arrangements to form patterns. For example, a first plurality of raised rib-like elements 304 can be arranged in a first pattern 314 and a second plurality of raised rib-like elements 304 arranged in a second pattern 316. The first and the second patterns 314, 316 of raised rib-like elements 304 can repeat across the thermoplastic film 200. As shown by FIG. 2, first and the second patterns 314, 316 of raised rib-like elements 304 can form a checkerboard pattern 220.

In one or more implementations, the first pattern 314 is visually distinct from the second pattern 316. As used herein, the term “visually distinct” refers to features of the web material which are readily discernible to the normal naked eye when the web material or objects embodying the web material are subjected to normal use.

As mentioned above, one or more implementations comprise thermoplastic bags with laminate having bonded protrusions. A laminate with bonded protrusions can comprise one or more SELF'ed films (e.g., film 200) non-continuously bonded to another film at the protrusions (e.g., raised rib-like elements 304 or troughs 312). As used herein, the terms “lamination,” “laminate,” and “laminated film,” refer to the process and resulting product made by bonding together two or more layers of film or other material. The term “bonding”, when used in reference to bonding of multiple layers of a multi-layer film, may be used interchangeably with “lamination” of the layers. According to methods of the present disclosure, adjacent layers of a multi-layer film are laminated or bonded to one another. The bonding purposely results in a relatively weak bond between the layers that has a bond strength that is less than the strength of the weakest layer of the film. This allows the lamination bonds to fail before the film layer, and thus the bond, fails.

The term laminate is also inclusive of co-extruded multilayer films comprising one or more tie layers. As a verb, “laminate” means to affix or adhere (by means of, for example, adhesive bonding, pressure bonding, ultrasonic bonding, corona lamination, static bonds, cohesive bonds, and the like) two or more separately made film articles to one another so as to form a multi-layer structure. As a noun, “laminate” means a product produced by the affixing or adhering just described.

As used herein the terms “partially discontinuous bonding” or “partially discontinuous lamination” refers to lamination of two or more layers where the lamination is substantially continuous in the machine direction or in the transverse direction, but not continuous in the other of the machine direction or the transverse direction. Alternately, partially discontinuous lamination refers to lamination of two or more layers where the lamination is substantially continuous in the width of the article but not continuous in the height of the article, or substantially continuous in the height of the article but not continuous in the width of the article. More particularly, partially discontinuous lamination refers to lamination of two or more layers with repeating bonded patterns broken up by repeating unbounded areas in either the machine direction or the transverse direction.

In one or more embodiments, the first and second films 402, 404 may be discontinuously bonded together via one or more of the methods of bonding films together as described in U.S. Pat. No. 8,603,609, the disclosure of which is incorporated in its entirety by reference herein. In particular, the first and second films may be bonded via one or more of MD rolling, TD rolling, DD ring rolling, SELF'ing, pressure bonding, corona lamination, adhesives, or combinations thereof. In some implementations, the first and second films may be bonded such that the bonded regions have bond strengths below a strength of the weakest film of the first and second films. In other words, the bonded regions may fail (e.g., break apart) before the first or second films fail. As a result, discontinuously bonding the first and second films may can also increase or otherwise modify one or more of the tensile strength, tear resistance, impact resistance, or elasticity of the films. Furthermore, the bonded regions between the first and second films may provide additional strength. Such bonded regions may be broken to absorb forces rather than such forces resulting in tearing of the film.

Furthermore, any of the pressure techniques (i.e., bonding techniques) described in U.S. Pat. No. 8,603,609 may be combined with other techniques in order to further increase the strength of the bonded regions while maintaining bond strength below the strength of the weakest layer of the multi-layer laminate film. For example, heat, pressure, ultrasonic bonding, corona treatment, or coating (e.g., printing) with adhesives may be employed. Treatment with a corona discharge can enhance any of the above methods by increasing the tackiness of the film surface so as to provide a stronger lamination bond, but which is still weaker than the tear resistance of the individual layers.

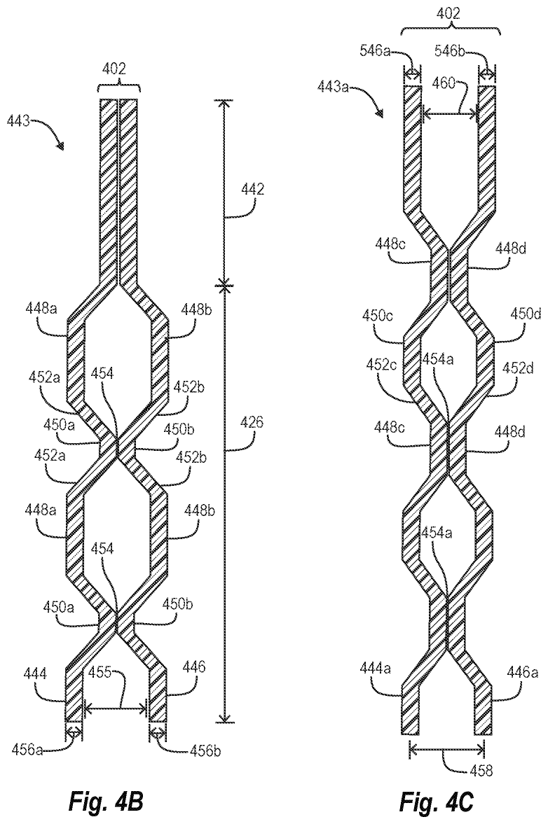

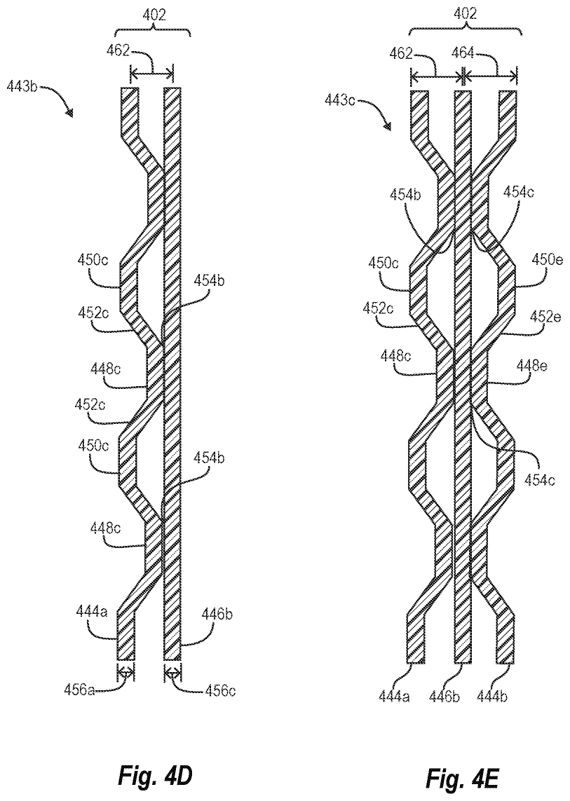

In any event, one or more implementations include a thermoplastic bag incorporating a laminate with bonded protrusions. For example, FIG. 4A illustrates an implementation of a thermoplastic bag 400 with a laminate having bonded deformations. The thermoplastic bag 400 includes a first sidewall 402 and a second sidewall 404. Each of the first and second sidewalls 402, 404 can comprise a laminate of the films (such as films 102a, 102b, 102c described above in relation to FIGS. 1A-1C). Each of the first and second sidewalls 402, 404 includes a first side edge 406, a second opposite side edge 408, a bottom edge 410 extending between the first and second side edges 406, 408. The first and second sidewalls 402, 404 also include a top edge 412 extending between the first and second side edges 406, 408 opposite the bottom edge 410.

In some implementations, the first sidewall 402 and the second sidewall 404 are joined together along the first side edges 406, the second opposite side edges 408, and the bottom edges 410. The first and second sidewalls 402, 404 may be joined along the first and second side edges 406, 408 and bottom edges 410 by any suitable process such as, for example, a heat seal. In particular, FIG. 4A illustrates that a first side seal 414 secures the first and second sidewalls 402, 404 together proximate the first side edges 404. Similarly, a second side seal 416 secures the first and second sidewalls 402, 404 together proximate the second side edges 408. In alternative implementations, the first and second sidewalls 402, 404 may not be joined along the side edges. Rather, the first and second sidewalls 402, 404 may be a single uniform piece. In other words, the first and second sidewalls 402, 404 may form a sleeve or a balloon structure.

In some implementations, the bottom edge 410 or one or more of the side edges 406, 408 can comprise a fold. In other words, the first and second sidewalls 402, 404 may comprise a single unitary piece of material. The top edges 412 of the first and second sidewalls 402, 404 may define an opening to an interior of the thermoplastic bag 400 having a laminate with bonded protrusions. In other words, the opening may be positioned opposite the bottom edge 410 of the thermoplastic bag 400 having a laminate with bonded protrusions. Furthermore, when placed in a trash receptacle, the top edges 412 of the first and second sidewalls 402, 404 may be folded over the rim of the receptacle.

In some implementations, the thermoplastic bag 400 having a laminate with bonded protrusions may optionally include a closure mechanism located adjacent to the top edges 412 for sealing the top of the thermoplastic bag 400 to form an at least substantially fully-enclosed container or vessel. As shown in FIG. 4A, in some implementations, the closure mechanism comprises a draw tape 418 positioned with in a hem 420. In particular, the top edges 412 of the first and second sidewalls 402, 404 may be folded back into the interior volume and may be attached to an interior surface by a hem seal 422 to form the hem 420. The draw tape 418 extends through the hem 420 along the top edge 412. The hem 420 includes apertures 424 (e.g., notch) extending through the hem 420 and exposing a portion of the draw tape 416. During use, pulling the draw tape 418 through the apertures 424 will cause the top edge 412 to constrict. As a result, pulling the draw tape 418 through the apertures 424 will cause the opening of the thermoplastic bag 400 having a laminate with bonded protrusions to at least partially close or reduce in size. The draw tape closure mechanism may be used with any of the implementations described herein.

Although the thermoplastic bag 400 having a laminate with bonded protrusions is described herein as including a draw tape closure mechanism, one of ordinary skill in the art will readily recognize that other closure mechanisms may be implemented into the thermoplastic bag 400 having a laminate with bonded protrusions. For example, in some implementations, the closure mechanism may include one or more of flaps, adhesive tapes, a tuck and fold closure, an interlocking closure (e.g., zipper closure), a slider closure, or any other closure structures known to those skilled in the art for closing a bag. Furthermore, while FIG. 4A illustrates that the thermoplastic bag 400 having a laminate with bonded protrusions is a trash bag, in other embodiments, the thermoplastic bag 400 having a laminate with bonded protrusions can comprise a food bag, or other type of thermoplastic bag.

As mentioned above, the thermoplastic bag 400 includes a laminate with bonded protrusions. In particular, one or more portions of the thermoplastic bag 400 includes a laminate of multiple thermoplastic films in which at least one comprises a SELF'ed film having protrusions (e.g., raised rib-like elements or troughs) bonded to another thermoplastic film. As used herein a SELF'ed film is a film comprising a strainable network of raised rib-like elements connected to troughs by stretched, transition regions. For example, FIG. 4A shows that a middle portion 426 of each sidewall 402, 404 is SELF'ed with a checkerboard pattern 220. The differing look and feel of the checkerboard pattern 220 can signal flexible and stretchable strength.

As shown by FIG. 4A, the checkboard pattern 220 can comprise a repeating pattern of raised rib-like elements. In particular, the checkboard pattern 220 of deformations can include a first plurality of rib-like elements arranged in a first pattern 436 and a second plurality of raised rib-like elements arranged in a second pattern 438. FIG. 4A further illustrates that the thermoplastic bag 400 includes a bottom region 440 extending from the bottom 410 of the thermoplastic bag 400 toward the top edges 412 that does not comprise a laminate with bonded protrusions. Indeed, the bottom region 440 is devoid of bonds and SELFing. Similarly, the thermoplastic bag 400 includes a top region 442 extending from the top edges 412 of the thermoplastic bag 400 toward the bottom edge 410 that does not comprise a laminate with bonded protrusions. Indeed, the top region 442 is devoid of bonds, SELFing, and strainable networks. In alternative implementations, the entire side walls 402, 404 are formed of, or include, a laminate with bonded protrusions.

FIG. 4B is a cross-sectional view of the first sidewall 402 taken along the line 4B-4B of FIG. 4A and illustrates the laminate with bonded protrusions 442 that forms the middle regions 426 of the first side wall 402. As shown, the laminate with bonded protrusions 443 comprises a first thermoplastic film 444 incrementally bonded to a second thermoplastic film 446. While FIG. 4B illustrates the first sidewall 402, one will appreciate that the second sidewall 404 can have the same configuration and features. As shown, the portion of the laminate 443 in the top region 442 of the thermoplastic bag 400 is un-SELF'ed. Furthermore, the first and second thermoplastic films 444, 446 in the portion of the laminate 443a in the top region 442 are adjacent to each other. In one or more implementations, the portions of the first and second thermoplastic films 444, 446 in the top region 442 are unbonded but indirectly joined to each other. Optionally, the portions of the first and second thermoplastic films 444, 446 in the top region 442 can be joined together (e.g. directly connected by adhesive at one or more locations); however, in various implementations, the portions of the first and second thermoplastic films 444, 446 in the top region 442 are proximate to each other and/or not in contact with each other and/or not joined to each other at one or more locations.

As shown, the portions of the first and second thermoplastic films 444, 446 in the middle region 426 are SELF'ed and intermittingly bonded to each other at protrusions. In particular, the SELF'ed portion of the first thermoplastic film 444 includes raised rib-like elements 448a separated by troughs 450a. As discussed above in relation to FIG. 3, stretched, thinner transitional regions 452a can connect the raised rib-like elements 448a and the troughs 450a. Each of the raised rib-like elements 448a and the troughs 450a is elongated since it has an overall length (into to the page) that is greater than its overall width.

The second thermoplastic film 446 has the same configuration as the first thermoplastic film 444, except that the second thermoplastic film 446 is configured and oriented as a mirrored version of the first thermoplastic film 444. In particular, the second thermoplastic film 446 is mirrored around an imaginary horizontal line disposed along the bottoms of the troughs 450a. As shown, the second thermoplastic film 446 includes raised rib-like elements 448b separated by troughs 450b. Stretched, thinner transitional regions 452b connect the raised rib-like elements 448b and the troughs 450b. Each of the raised rib-like elements 448b and the troughs 450b is elongated since it has an overall length (into to the page) that is greater than its overall width.

Due to the mirrored configuration, the raised rib-like elements 448b and the troughs 450b of the second thermoplastic film 446 have the same size and orientation as the raised rib-like elements 448a and the troughs 450a of the first thermoplastic film 444. Furthermore, all of the troughs 450a, 450b face inward while all of the raised rib-like elements 448a, 448b face outward. The first thermoplastic film 444 is aligned both side-to-side and lengthwise (into the page) with the second thermoplastic film 446. In various implementations, for any patterned area of any laminate disclosed herein, a second thermoplastic film may not be a mirrored version of the first thermoplastic film, but may differ from the first thermoplastic film. In particular, the raised rib-like elements and the troughs of the second thermoplastic film may differ in height, width, etc. from the raised rib-like elements and the troughs of the first thermoplastic film.

Additionally, the first thermoplastic film 444 is secured to the second thermoplastic film 446 by a plurality of bonds 454 between the troughs 450a of the first thermoplastic film 444 and the troughs 450b of the second thermoplastic film 446. The plurality of bonds 454 directly connects the troughs 450a of the first thermoplastic film 444 to the troughs 450b of the second thermoplastic film 446 such that each of the troughs 450a is directly connected to a single one of the troughs 450b. Similarly, each of the troughs 450b of the second thermoplastic film 446 is directly bonded to a single one of the troughs 450a of the first thermoplastic film 444. In alternative implementations, for any patterned area of any laminate disclosed herein, multiple troughs of the first thermoplastic film may be directly connected to a single trough of the second thermoplastic film. Any of the bonds disclosed herein can be formed by one or more adhesives and/or fused portions, which extend continuously or discontinuously along part or parts of about all, approximately all, substantially all, nearly all, or all of either or both of the connected troughs. A suitable adhesive for connecting films may be used, such as 5100-N ZP (Full Care), available from H.B. Fuller of Saint Paul, Minn., United States of America. For example, the thermoplastic films 444, 446 may be fused together by the application of heat and/or pressure as they are held in contact.

FIG. 4B further illustrates that when one type of protrusion (e.g., the troughs 450a, 450b) are bonded together, the other type of protrusion (e.g., the raised rib-like elements 448a, 448b) are separated by a distance 455. The distance 455 separating the raised rib-like elements 448a, 448b is greater than a combination of a gauge 456a of the first thermoplastic film 444 and a gauge 456b of the second thermoplastic film 446. The distance 455 separating the unbonded protrusions is the increased effective gauge of the laminate with bonded protrusions 443.

While FIG. 4B illustrate a laminate with bonded protrusions in which the bonded protrusions are troughs, alternative implementations comprise laminates in which the raised rib-like elements are the bonded protrusions. For example, FIG. 4C illustrates an alternative implementation of the first sidewall 402 comprising a laminate with bonded protrusions 443a in which the raised rib-like elements are the bonded protrusions. In particular, as shown, the laminate with bonded protrusions 443a comprises a first thermoplastic film 444a bonded to a second thermoplastic film 446a.

As shown, the portions of the first and second thermoplastic films 444a, 446a in the middle region 426 are SELF'ed and intermittingly bonded to each other at protrusions. In particular, the SELF'ed portion of the first thermoplastic film 444a includes raised rib-like elements 448c separated by troughs 450c. Stretched, thinner transitional regions 452c connect the raised rib-like elements 448b and the troughs 450b. As mentioned above, the transitional regions 452c are stretched and thinner compared to the raised rib-like elements and troughs.

The second thermoplastic film 446a has the same configuration as the first thermoplastic film 444a, except that the second thermoplastic film 446a is configured and oriented as a mirrored version of the first thermoplastic film 444a. In particular, the second thermoplastic film 446a is mirrored around an imaginary horizontal line disposed along the bottoms of the troughs 450c. As shown, the second thermoplastic film 446a includes raised rib-like elements 448d separated by troughs 450d. Stretched, thinner transitional regions 452d connect the raised rib-like elements 448d and the troughs 450d.

Due to the mirrored configuration, the raised rib-like elements 448d and the troughs 450d of the second thermoplastic film 446a have the same size and orientation as the raised rib-like elements 448c and the troughs 450c of the first thermoplastic film 444a. Furthermore, all of the troughs 450c, 450d face outward while all of the raised rib-like elements 448c, 448d face inward. The first thermoplastic film 444a can be aligned both side-to-side and lengthwise (into the page) with the second thermoplastic film 446a.

Additionally, the first thermoplastic film 444a is secured to the second thermoplastic film 446a by a plurality of bonds 454a between the raised rib-like elements 448c of the first thermoplastic film 444a and the raised rib-like elements 448d of the second thermoplastic film 446a. The plurality of bonds 454a directly connects the raised rib-like elements 448c of the first thermoplastic film 444a to the raised rib-like elements 448d of the second thermoplastic film 446a such that each of the raised rib-like elements 448c is directly connected to a single one of the raised rib-like elements 448d. Similarly, each of the raised rib-like elements 448d of the second thermoplastic film 446a is directly bonded to a single one of the raised rib-like elements 448c of the first thermoplastic film 444a. In alternative implementations, for any patterned area of any laminate disclosed herein, multiple raised rib-like elements of the first thermoplastic film may be directly connected to a single raised rib-like elements of the second thermoplastic film.

Additionally, the unSELF'ed portion of the thermoplastic films 444a, 446a are offset or separated by a gap 460 rather than being adjacent as in the laminate 443 of FIG. 4B. The gap 460 is greater than a combination of a gauge 456a of the first thermoplastic film 444a and a gauge 456b of the second thermoplastic film 446a.

Similar to FIG. 4B, FIG. 4C also illustrates that when one type of protrusion (e.g., the raised rib-like elements 448c, 448d) are bonded together, the other type of protrusion (e.g., the troughs 450c, 450d) are separated by a distance 458. The distance 458 separating the troughs 450c, 450d is greater than a combination of a gauge 456a of the first thermoplastic film 444a and a gauge 456b of the second thermoplastic film 446a. The distance 458 separating the unbonded protrusions is the increased effective gauge of the laminate with bonded protrusions 443a.

While FIGS. 4B and 4C illustrate laminates with bonded protrusions of one film bonded to protrusions of a second film, alternative implementations comprise laminates in which the protrusions are not bonded to protrusions of a second film. For example, FIG. 4D illustrates an alternative implementation of the first sidewall 402 comprising a laminate with bonded protrusions 443b in which raised rib-like elements are bonded to a flat film (e.g., an unSELF'ed film or a film that is devoid of strainable networks). In particular, as shown, the laminate with bonded protrusions 443b comprises the first thermoplastic film 444a bonded to a second thermoplastic film 446c. While FIG. 4D illustrates that the second thermoplastic film 446c is flat or of uniform gauge, in alternative implementations the second thermoplastic film 446c can comprise varying gauge (e.g., a ring rolled film).

As shown by FIG. 4D, the first thermoplastic film 444a is secured to the second thermoplastic film 446c by a plurality of bonds 454b between the raised rib-like elements 448c of the first thermoplastic film 444a and the second thermoplastic film 446b. The plurality of bonds 454b directly connects the raised rib-like elements 448c to the second thermoplastic film 446b. Additionally, the troughs 450c are separated from the second thermoplastic film 446c by a distance 462. The distance 462 separating the troughs 450c from the second thermoplastic film 446b is greater than a combination of a gauge 456a of the first thermoplastic film 444a and a gauge 456c of the second thermoplastic film 446b. The distance 462 separating the troughs 450c from the second thermoplastic film 446b is the increased effective gauge of the laminate with bonded protrusions 443b.

While FIG. 4D illustrates the raised rib-like elements 448c of the first thermoplastic film 444a bonded to the second thermoplastic film 446b, in alternative implementations the troughs 450c are bonded to the second thermoplastic film 446b.While FIGS. 4B-4D illustrate laminates with two films, alternative implementations comprise laminates with bonded protrusions comprising more than two films. For example, FIG. 4E illustrates an alternative implementation of the first sidewall 402 comprising a laminate with bonded protrusions 443c with three films. In particular, as shown, the laminate with bonded protrusions 443c is the same as the laminate with bonded protrusions 443b albeit that a third thermoplastic film 444d is also bonded to the second thermoplastic film 446b.

As shown by FIG. 4E, the third thermoplastic film 444b is secured to the second thermoplastic film 446b by a plurality of bonds 454c between the raised rib-like elements 448e of the third thermoplastic film 444b and the second thermoplastic film 446c. The plurality of bonds 454c directly connects the raised rib-like elements 448e to the second thermoplastic film 446b. Additionally, the troughs 450e are separated from the second thermoplastic film 446c by a distance 464. The distance 464 separating the troughs 450e from the second thermoplastic film 446b is greater than a combination of a gauge of the third thermoplastic film 444b and a gauge 456c of the second thermoplastic film 446b. The combined distances 462 and 464 are the increased effective gauge of the laminate with bonded protrusions 443c.

In the implementations of FIGS. 4A-4E, since all of the bonds are oriented in the machine direction, the bonds provide the bags with a relatively higher bending stiffness in the machine direction, and a relatively lower bending stiffness in the transverse direction. Furthermore, in the implementations of FIGS. 4A-4E since the unbonded, regions separated by the distance 445 are linear pathways disposed in parallel, the pathways provide the bags with relatively lower bending stiffness at angles taken perpendicular to the pathways.

While FIG. 4A illustrates a thermoplastic bag in which the sidewalls comprise a laminate with bonded protrusions, in alternative implementations other portions of the thermoplastic bag can comprise a laminate with bonded protrusions. For example, in one or more embodiments, the drawtape, or a portion thereof, comprises a laminate with bonded protrusions. In particular, in one or more embodiments, the drawtape 418 (see FIG. 4A) comprises a laminate with bonded protrusions. In particular, the drawtape can comprise any of the laminates with bonded protrusions shown and described in relation to FIGS. 4B-4E. In one or implementations, the sidewalls 402, 404 comprise a first laminate with bonded protrusions with a first configuration (e.g., one of laminates 443-443c) and the drawtape 418 comprises a second laminate with bonded protrusions with a second configuration (e.g., another of laminates 443-443c). In alternative implementations, the drawtape comprises a laminate with bonded protrusions while the sidewalls of the bag comprise a single layer or a SELF'ed laminate without bonded protrusions. In other words, in one or more implementations, the only part of the thermoplastic bag comprising a laminate with bonded protrusions is the drawtape.

A laminate with bonded protrusions can provide a drawtape with improved feel, can minimize roping of the drawtape (e.g., folding of the drawtape into a string or rope configuration), provided the drawtape with an increased effective gauge, enable the drawtape to have a reduced basis weight.

In one or more implementations, the entire drawtape comprises a laminate with bonded protrusions. In alternative implementations, only a portion of the drawtape within the apertures 424 (or portions that are able to be pulled out of the apertures 424). In such implementations, a portion of an additional thermoplastic film can be bonded to the drawtape to form the laminate with bonded protrusions. In such implementations, the additional thermoplastic film (e.g., the second thermoplastic film) can have a width equal to a width of the drawtape but a length shorter than a length of the drawtape.

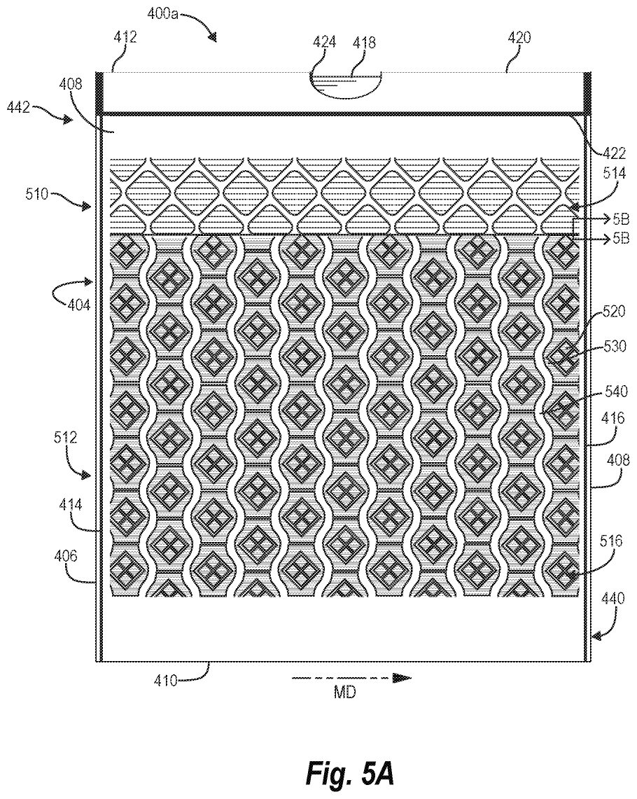

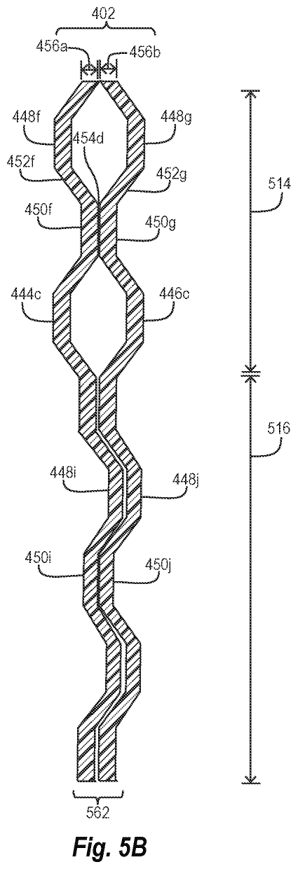

FIG. 4A illustrates a thermoplastic bag in which the entire patterned portion of the sidewalls comprise a laminate with bonded protrusions, in alternative implementations some patterned portions can comprise laminates with bonded protrusions, while other patterned portions comprise traditional laminates. For example, FIG. 5A illustrates a thermoplastic bag 400a similar to the thermoplastic bag 400 of FIG. 4A albeit with pattern regions comprising laminates with bonded protrusions and patterned regions devoid of laminates with bonded protrusions. The features of the thermoplastic bag 400a that are the same as the features of the thermoplastic bag 400 include the same reference numerals.

As shown by FIG. 5A, the thermoplastic bag 400a includes an upper region 510 with a first SELFing pattern 514 and a middle region 512 with a second SELFing pattern 516. The second SELFing pattern 516 includes a first plurality of raised rib-like elements 530 in a macro pattern (a bulbous pattern) and a second plurality of raised rib-like elements 520 in a micro pattern (a diamond pattern). As shown, the second plurality of raised rib-like elements 520 in the micro pattern are nested within the macro patterns. Furthermore, the second SELFing pattern 516 includes web areas 540. The web areas 540 can surround the micro and the macro patterns of raised rib-like elements. Furthermore, as shown by FIG. 5A, the web areas 540 are arranged in a sinusoidal pattern. The pattern of web areas 540 can affect how the raised rib-like elements expand and move when being strained and subsequently released. Furthermore, the pattern of the web areas 540 can direct liquid to the bottom of the bag 400a.

FIG. 5B illustrates is a cross-sectional view of the first sidewall 402 of the thermoplastic bag 400a of FIG. 5A taken along the line 5B-5B of FIG. 5A. As shown by FIG. 5B, as shown, the portion of the first sidewall 402 in the upper region 514 of the thermoplastic bag 400a comprises a laminate with bonded protrusions while the portion of the first sidewall 402 in the middle region 516 comprises a traditional laminate. More particularly, the portion of the first thermoplastic film 444c in the upper region 514 can comprise raised rib-like elements 448f and troughs 450f connected by stretched, thinner transitional regions 452f. Similarly, the portion of the second thermoplastic film 446c in the upper region 514 can comprise raised rib-like elements 448g and troughs 450g connected by stretched, thinner transitional regions 452g. As shown, the troughs 450f of the first thermoplastic film 444c in the upper region 514 are secured to troughs 450g of the second thermoplastic film 446c by bonds 454d as described above to form a laminate with bonded protrusions.

The portion of the first thermoplastic film 444c in the middle region 516 of the thermoplastic bag 400a comprises raised rib-like elements 448i and troughs 450i connected by stretched, thinner transitional regions 452i. Similarly, the portion of the second thermoplastic film 446c in the middle region 516 can comprise raised rib-like elements 448j and troughs 450j connected by stretched, thinner transitional regions 452j. In contrast to the portions of the first and second thermoplastic films 444c, 446c in the upper region 514 that are mirrored, the portions of the first and second thermoplastic films 444c, 446c in the middle region 516 have the same orientation and are not mirrored. Thus, the portions of the first and second thermoplastic films 444c, 446c do not comprise laminates with bonded protrusions.

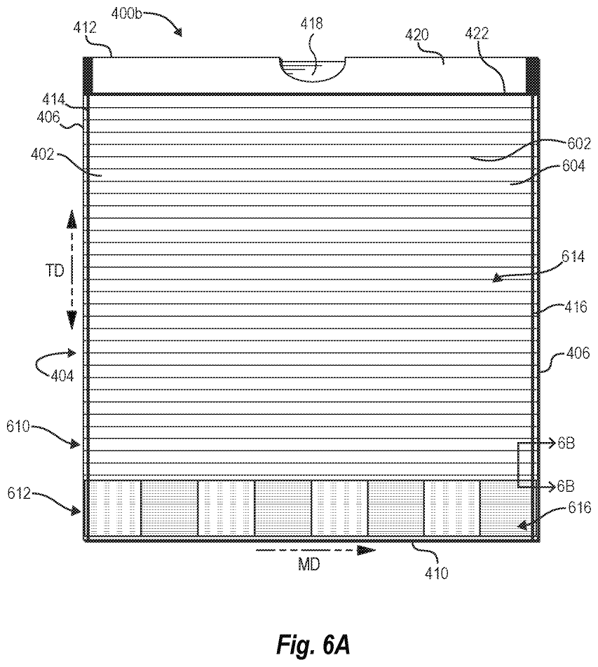

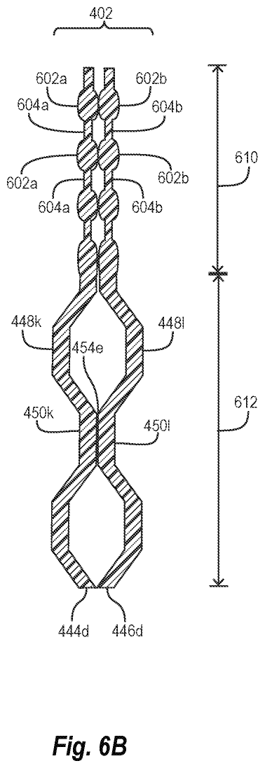

All of the patterned regions of the thermoplastic bags 400, 400a shown and described above comprise SELFing. In alternative implementations, thermoplastic bags comprising laminates with bonded protrusions can include patterned regions formed from cold deformation techniques other than SELFing. For example, FIG. 6A illustrates a thermoplastic bag 400b similar to the thermoplastic bag 400 of FIG. 4A albeit a SELF'ed pattern region comprising a laminate with bonded protrusions and ring rolled patterned region devoid of laminates with bonded protrusions. The features of the thermoplastic bag 400b that are the same as the features of the thermoplastic bag 400 include the same reference numerals.

As shown by FIG. 6A, the thermoplastic bag 400b includes an upper region 610 with a ring-rolled pattern 614 and a bottom region 612 with a checkerboard SELF'ing pattern 616. The ring-rolled pattern 614 includes a first plurality of thicker ribs 602 that alternate with thinner stretched webs 604.

FIG. 6B illustrates is a cross-sectional view of the first sidewall 402 of the thermoplastic bag 400b of FIG. 6A taken along the line 6B-6B of FIG. 6A. As shown by FIG. 6B, as shown, the portion of the first sidewall 402 in the bottom region 612 of the thermoplastic bag 400b comprises a laminate with bonded protrusions while the portion of the first sidewall 402 in the upper region 610 comprises a ring-rolled laminate. More particularly, the portion of the first thermoplastic film 444d in the bottom region 612 comprises raised rib-like elements 448k and troughs 450k connected by stretched, thinner transitional regions 452k. Similarly, the portion of the second thermoplastic film 446d in the bottom region 614 can comprise raised rib-like elements 448l and troughs 450l connected by stretched, thinner transitional regions 452l. As shown, the troughs 450k of the first thermoplastic film 444d in the bottom region 614 are secured to troughs 450l of the second thermoplastic film 446d by bonds 454e as described above to form a laminate with bonded protrusions.

The portions of the first thermoplastic film 444d and the second thermoplastic film 446d in the upper region 610 of the thermoplastic bag 400b are ring rolled (in particular TD ring rolled). As shown the ribs 602a, 602b of the first and second thermoplastic films 444d, 446d alternate with thinner, stretched webs 604a, 604b. Furthermore, the thicker ribs 602a, 602b of the first and second thermoplastic films 444d, 446d are bonded together. Nonetheless, the portions of the first and second thermoplastic films 444d, 446d in the upper region 610 do not comprise laminates with bonded protrusions as there are no raised rib-like elements or troughs of a strainable bonded to another film.

As shown by FIGS. 5A and 6A, thermoplastic bags of one or more implementations can comprise areas (e.g., upper regions or bottom regions) reinforced with a laminate with bonded protrusions. In particular, thermoplastic bags of one or more implementations can comprise laminates with bonded protrusions in areas where consumers interact with the bags or feel extra support is desirable.

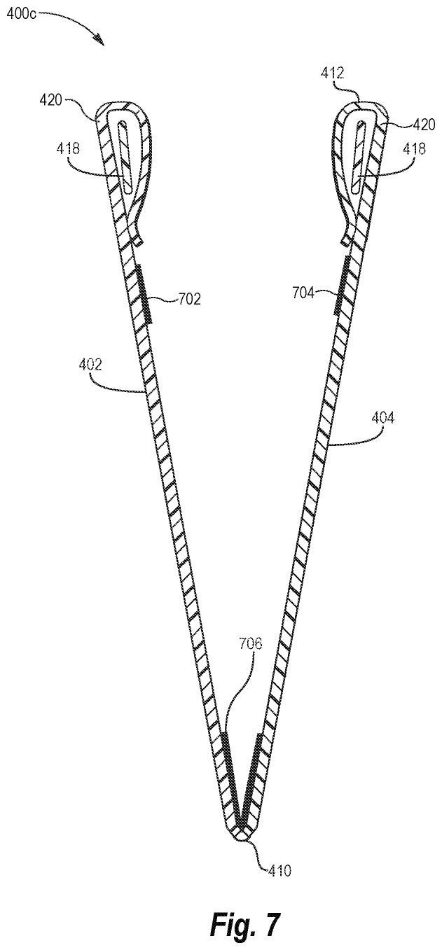

While the thermoplastic bags 400, 400a, 400b shown and described above comprise multi-layered sidewalls (e.g., have a bag-in-bag configuration) that are formed from laminates with bonded protrusions, alternative implementations can comprise laminates with bonded protrusions in the form of strips that are secured to one or more zones or regions to reinforce the bag. In other words, a thermoplastic bag can have a traditional configuration (weather single layer sidewalls or bag-in-bag configurations) with a laminate with bonded protrusions bonded to one or more zones or regions. For example, FIG. 7 illustrates a cross-sectional view of a single-layered bag 400c with reinforcing strips comprising laminates with bonded protrusions bonded to the thermoplastic bag 400c. The features of the thermoplastic bag 400c that are the same as the features of the thermoplastic bag 400 include the same reference numerals.

As shown in FIG. 7, the thermoplastic bag 400c can comprise zones reinforced with laminates with bonded protrusions. In particular, the thermoplastic bag 400c can include reinforcing strips of laminates with bonded protrusions 702, 704 just below the hems 420. The laminates with bonded protrusions 702, 704 just below the hems 420 can provide increased strength to portions of the thermoplastic bag 400c that are commonly folded over a trash bin. Additionally, the laminates with bonded protrusions 702, 704 just below the hems 420 can provide increased effective gauge to areas commonly handled by users to provide the advantages discussed above.

Furthermore, the thermoplastic bag 400c can include a laminate with bonded protrusions 706 along the bottom edge 410 of the thermoplastic bag 400c. The laminate with bonded protrusions 706 along the bottom edge 410 can provided increased strength to the bottom of the thermoplastic bag 400c where trash or other objects may strain the bag. Thus, the laminate with bonded protrusions 706 along the bottom edge 410 can help provide increased strength and reduce leaks.

The reinforcing strips of laminates with bonded protrusions 702, 704, 706 can be secured to the sidewalls of the thermoplastic bag 400c by adhesive bonding, pressure bonding, ultrasonic bonding, a combination of heat and pressure, corona lamination, etc.

In some implementations, the thermoplastic bag 400c can comprise the laminate with bonded protrusions 706 along the bottom edge 410 but lack the laminates with bonded protrusions 702, 704 just below the hems 420. Alternatively, the thermoplastic bag 400c can comprise the laminates with bonded protrusions 702, 704 just below the hems 420 but lack the laminate with bonded protrusions 706 along the bottom edge 410. In still further embodiments, the entire sidewalls can be reinforced by laminates with bonded protrusions.

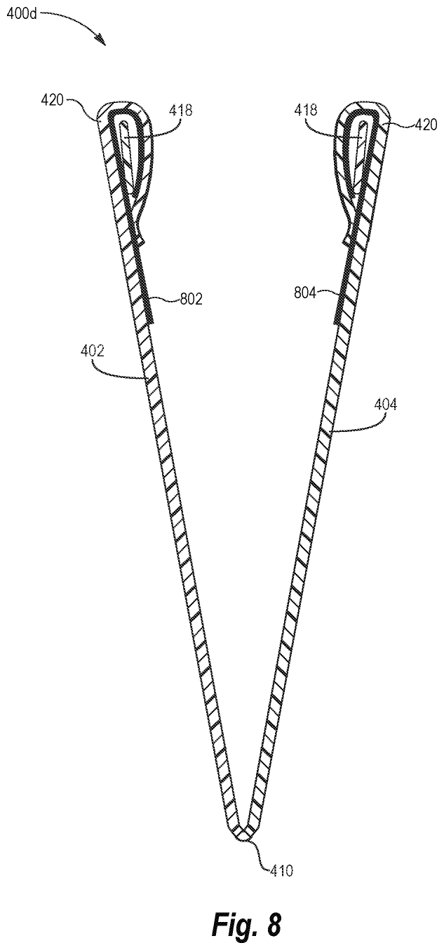

In any event, implementations can comprise laminates with bonded protrusions bonded to a thermoplastic bag in one or more regions to provide increased strength and effective gauge. For example, FIG. 8 illustrates a cross-sectional view of another single-layered bag 400d with zones reinforced with laminates with bonded protrusions. The features of the thermoplastic bag 400d that are the same as the features of the thermoplastic bag 400 include the same reference numerals. As shown in FIG. 8, the thermoplastic bag 400d can comprise zones reinforced with laminates with bonded protrusions. In particular, the thermoplastic bag 400d can include laminates with bonded protrusions 802, 804 as part of the hems 420. Thus, the thermoplastic bag 400d can include increased strength and increased effective gauge both in the regions that users commonly handle and that is often strained when moving a bag full of trash or other objects.

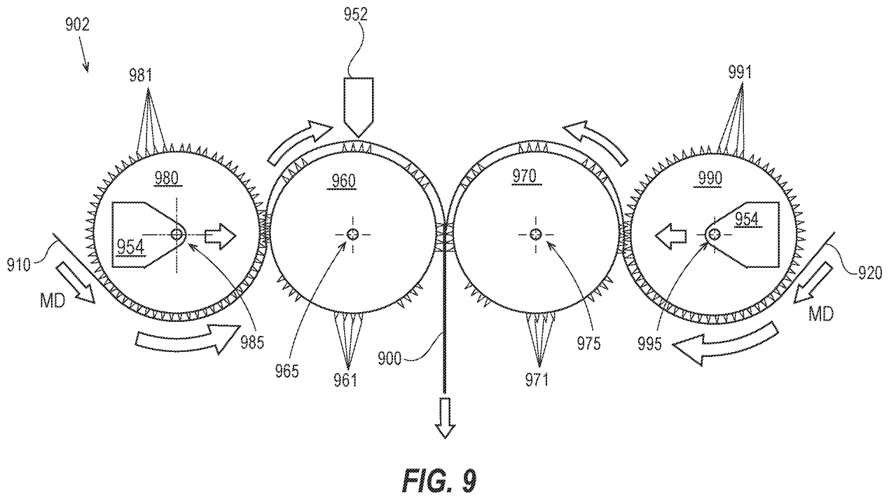

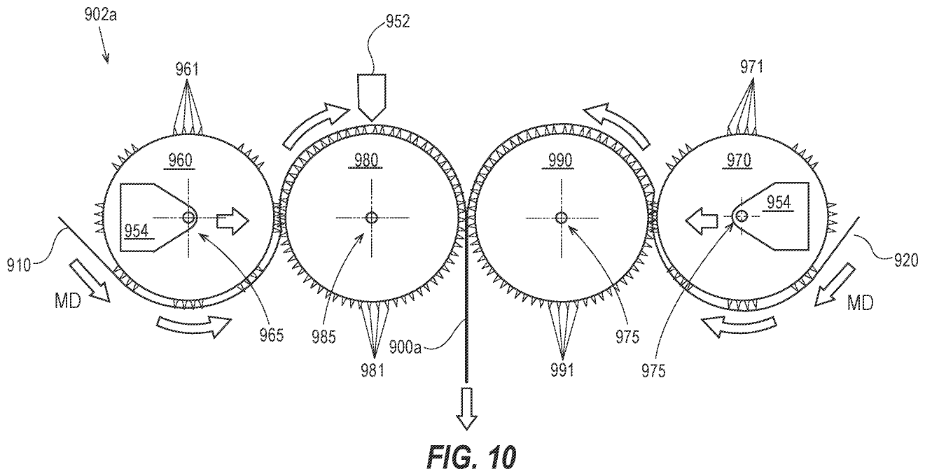

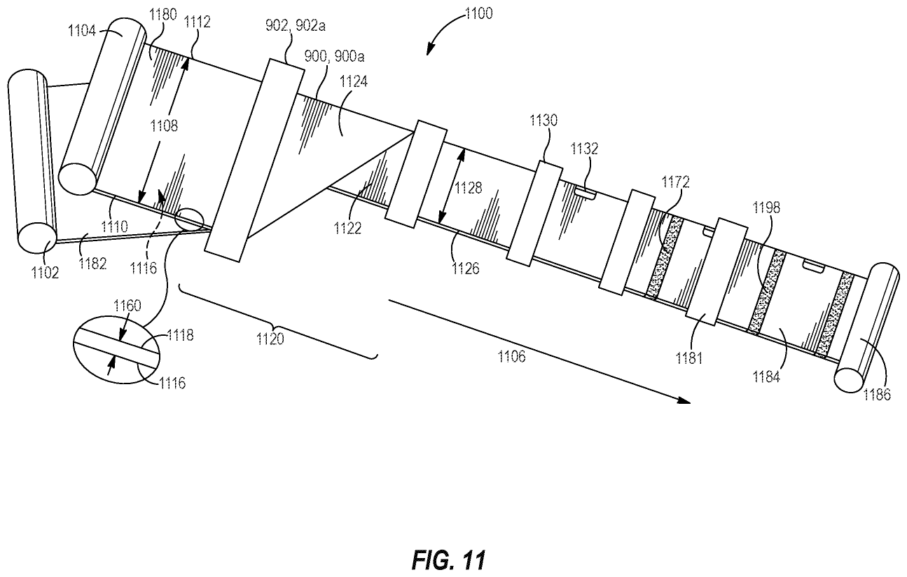

One or more implementations include methods of forming thermoplastic bags with laminates having bonded protrusions. FIGS. 9-11 and the accompanying description describe such methods. Of course, as a preliminary matter, one of ordinary skill in the art will recognize that the methods explained in detail herein can be modified. For example, various acts of the method described can be omitted or expanded, additional acts can be included, and the order of the various acts of the method described can be altered as desired. FIGS. 9 and 10 illustrate example processes of forming laminates with bonded protrusions. FIG. 11, on the other hand, illustrates an example process of forming a thermoplastic bag include laminates having bonded protrusions.

FIG. 9 illustrates an assembly 902 with four solid state formation rolls (i.e., a first patterning roll 960, a second patterning roll 970, a third patterning roll 980, and a fourth patterning roll 990). The patterning rolls stretch a first film 910 and a second film 920 and joins the films together to form a laminate with bonded protrusions 900. The first and third patterning rolls 960 and 980 incrementally stretch the first film 910, while the second and fourth patterning rolls 970 and 990 incrementally stretch the second film 920. While the first film 910 is engaged with the first patterning roll 960 and while the second film 920 is engaged with the second patterning roll 970, the first and second patterning rolls 960 and 970 join together the first and second films 910 and 920 to form the laminate 900. In FIG. 9, the overall machine direction for the first film 910 is shown on the left as an arrow pointing to the right and the overall machine direction for the second film 920 is shown on the right as an arrow pointing to the left; however, for each of these films, the precise machine direction at any particular point is defined by the path of the film as it travels through the machine.

The first patterning roll 960 is a solid state formation roll with discrete teeth that rotates clockwise around an axis 965 oriented in the transverse or cross direction. On the first patterning roll 960, each of the teeth 961 is oriented lengthwise in the cross direction, such that its overall length is parallel with the axis 965. Each of the teeth 961 is discrete with an overall length that does not extend all the way across the roll face of the roll 960. The teeth 961 disposed linearly, in parallel, side-by-side, with adjacent teeth separated by gaps. Each of the teeth 961 is elongated since it has an overall length that is greater than its overall width. Each of the teeth 961 has a distal end that forms a tip, which is the part of the teeth that is farthest from the axis 965. The second patterning roll 970 is also a solid state formation roll with discrete teeth 971, and is configured in the same way as the first patterning roll 960, except that the roll 970 rotates counterclockwise around an axis 975 oriented in the transverse direction. The rolls 960 and 970 are unmated joining rolls, with respect to each other, and are registered with each other in both the machine direction and the cross direction, to enable the connection of the films 910 and 920.

The first patterning roll 960 is also positioned with respect to the second patterning roll 970 such that, as the rolls rotate, while the first film 910 is engaged with the first patterning roll 960 and while the second film 920 is engaged with the second patterning roll 970, the tips of the teeth 961 come within joining proximity of the tips of the teeth 971; that is, when the tips of the teeth 961 pass by the tips of the teeth 971, a film engaged with the teeth 961 can be directly connected to a film engaged with the teeth 971. As a result, the rolls 960 and 970 can join films to form a laminate, as they rotate; so, the rolls 960 and 970 are joining rolls with respect to each other.

The first patterning roll 960 is registered with the second patterning roll 970 in both the machine direction and the cross direction, to enable the connection of the films 910 and 920. The registration in the machine direction includes controlling the relative angular positions of the rolls 960 and 970, such that, as the rolls 960 and 970 rotate, the tips of the teeth 961 and 971 pass by each other in joining proximity, so the opposing tips of the protrusions can position protrusions from the first film 910 with protrusions from the second film 920 along their overall lengths, to form direct connections. The registration in the transverse direction includes positioning the roll faces of the rolls 960 and 970, such that, as the rolls 960 and 970 rotate, when the tips of the teeth 961 are in joining proximity with the tips of the teeth 971, the tips are aligned in the cross direction opposite from each other, so the opposing tips can position corrugations from the first film 910 with protrusions from the second film 920 across their widths, to form direct connections.

The third patterning roll 980 is a ring-roll that rotates counterclockwise around an axis 985 oriented in the cross direction. The third patterning roll 980 has a roll face with a cylindrical base and a plurality of rigid, elongated, continuous teeth 981 attached to the base as radial projections. The teeth 981 are like rows of rings, and are disposed linearly, in parallel, side-by-side, with adjacent rings separated by gaps. Each of the rings 981 is elongated since it has an overall length that is greater than its overall width. And, each of the teeth 981 is oriented lengthwise in the machine direction, such that its overall length is parallel with the rotation of the roll 980. Each of the teeth 981 is continuous with an overall length that continues all the way around the roll face of the roll 980. Each of the teeth 981 has a distal outer surface that forms a tip, which is the part of the protrusion that is farthest from the axis 995. The fourth patterning roll 990 is also a ring-roll with teeth 991, and is configured in the same way as the third patterning roll 980, except that the roll 990 rotates clockwise around an axis 995 oriented in the cross direction.

The third patterning roll 980 is positioned with respect to the first patterning roll 960 such that, as the rolls rotate, the tips of the continuous teeth 981 mate with the tips of the discrete teeth 961; that is, the tips of the teeth 961 pass within the radius formed by the tips of the teeth 981 and the tips of the teeth 981 pass within the radius formed by the tips of the teeth 961. As a result, there is an intermeshing of the teeth 961 and 981 as the rolls 960 and 980 rotate; so, the rolls 960 and 980 are mated, with respect to each other.

The third patterning roll 980 is registered with the first patterning roll 960 in the cross direction, to enable the incremental stretching of the film 910. The registration in the cross direction includes positioning the roll faces of the rolls 960 and 980, such that, as the rolls 960 and 980 rotate, the tips of the continuous teeth 981 are offset in the cross direction from the tips of the discrete teeth 961, so the tips can intermesh to form incrementally stretched corrugations in the first film 910. Since the teeth 981 are continuous, there is no need to register the third patterning roll 980 with the first patterning roll 960 in the machine direction.

The fourth patterning roll 990 is positioned and registered with the second patterning roll 970 in the same way that the third patterning roll 980 is positioned and registered with the first patterning roll 960, such that, the rolls 990 and 970 are mated, with respect to each other, and the tips of the continuous teeth 991 intermesh with the tips of the discrete teeth 971, to form incrementally stretched corrugations in the second film 920. Since the teeth 991 are continuous, there is no need to register the fourth patterning roll 990 with the second patterning roll 970 in the machine direction.

A first web supply apparatus is positioned upstream from the third patterning roll 980, and supplies the first film 910 in the form of a web; a web supply apparatus can take any convenient form, such as an unwind stand. Similarly, a second web supply apparatus is positioned upstream from the fourth patterning roll 990, and supplies the second film 920 in the form of a web. An adhesive application apparatus 952 is optionally positioned adjacent to the first patterning roll 960 and applies adhesive to a film engaged with the teeth 961 of the roll 960; an adhesive application apparatus can take any convenient form, such as a glue head with a comb shim, a gravure print roll, an inkjet printer, etc. A force application apparatus 954 includes a first part that pushes and holds the third patterning roll 980 into mating relation with the first patterning roll 960 and a second part that pushes and holds the fourth patterning roll 990 into mating relation with the second patterning roll 970; a force application apparatus can take any convenient form, such as air cylinders that move the rolls' rotating axes.

The first film 910 generally moves through the machine 902 from left to right, as indicated by its overall machine direction. The first film 910 moves from the first web supply apparatus onto the third patterning roll 980, then between the intermeshing teeth 961 and 981 of the mated rolls 960 and 980, then past the adhesive application apparatus 952, and then into the joining proximity between the teeth 961 and 971 of the rolls 960 and 970. As the first film 910 is supplied by the first web supply apparatus, the first film 910 has the form of a substantially flat, unformed, continuous web. The first film 910 moves from the first web supply apparatus and follows the roll face of the third patterning roll 980. As the third patterning roll 980 rotates, the first film 910 moves into and engages with the intermeshing teeth 981 and 961 of the patterning rolls 980 and 960, which incrementally mechanically stretch the first film 910 to form a plurality of raised rib-like elements and troughs, as described above. As the patterning rolls 980 and 960 rotate, the first film 910 moves out of the intermeshing teeth 961 and 981 and disengages from the teeth 981 of the third patterning roll 980 but remains engaged with the teeth 961 of the first patterning roll 960 and follows the roll face of the first patterning roll 960. As the first patterning roll 960 rotates farther, the first film 910 continues to follow the roll face of the first patterning roll 960, remaining engaged with the teeth 961, and moving past the adhesive application apparatus 952, which applies adhesive to the troughs of the corrugations of the first film 910. The adhesive application apparatus 952 can be positioned adjacent to the first patterning roll 960 at any convenient location downstream from the disengagement of the first and third rolls 960 and 980 and upstream from the joining proximity of the first and second rolls 960 and 970. In alternative embodiments, another adhesive application apparatus (in addition to or instead of the adhesive application apparatus 952) can be adjacent to the second patterning roll 970 at any convenient location downstream from the disengagement of the second and fourth rolls 970 and 990 and upstream from the joining proximity of the first and second rolls 960 and 970. As the first patterning roll 960 rotates even farther, the first film 910 continues to follow the roll face of the first patterning roll 960, remaining engaged with the teeth 961, and moving between the patterning rolls 960 and 970.

The second film 920 generally moves through the machine 902 from right to left, as indicated by its overall machine direction. The second film 920 moves 920-m from the second web supply apparatus 950-2 onto the fourth patterning roll 990, then between the intermeshing teeth 971 and 991 of the mated rolls 970 and 990, and then into the joining proximity between the teeth 971 and 991 of the rolls 970 and 990. As the second film 920 is supplied by the second web supply apparatus 950-2, the second film 920 has the form of a substantially flat, unformed, continuous web. The second film 920 moves from the second web supply apparatus and follows the roll face of the fourth patterning roll 990. As the fourth patterning roll 990 rotates, the second film 920 moves into and engages with the intermeshing teeth 991 and 971 of the patterning rolls 990 and 970, which incrementally mechanically stretch the second film 920 to form a plurality of raised rib-like elements and troughs, as described above. As the patterning rolls 990 and 970 rotate, the second film 920 moves out of the intermeshing teeth 991 and 971 and disengages from the teeth 991 of the fourth patterning roll 990 but remains engaged with the teeth 971 of the second patterning roll 970 and follows the roll face of the second patterning roll 970. As the second patterning roll 970 rotates farther, the second film 920 continues to follow the roll face of the second patterning roll 970, remaining engaged with the teeth 971. As the second patterning roll 970 rotates even farther, the second film 920 continues to follow the roll face of the second patterning roll 970, remaining engaged with the teeth 971, and moving between the patterning rolls 970 and 960.

As the first patterning roll 960 and the second patterning roll 970 rotate farther, the first film 910 is engaged with the first patterning roll 960, the second film 920 is engaged with the second patterning roll 970, and the tips 962 of the teeth 961 of the first patterning roll 960 come into joining proximity with the tips 972 of the teeth 971 of the second patterning roll 970, such that the raised rib-like elements of the first film 910 become bonded to the raised rib-like elements of the second film 920, to form the laminate with bonded protrusions 900, which moves off of the rolls 960 and 970 in its finished form.

FIG. 10 illustrates an assembly 902a with four solid state formation rolls similar to the assembly 900 of FIG. 9, albeit that the order of the pairs patterning rolls are switched. The first and third patterning rolls 960 and 980 incrementally stretch the first film 910, while the second and fourth patterning rolls 970 and 990 incrementally stretch the second film 920. While the first film 910 is engaged with the first patterning roll 960 and while the second film 920 is engaged with the second patterning roll 970, the first and second patterning rolls 960 and 970 join together the first and second films 910 and 920 to form the laminate 900.

As the patterning rolls rotate farther, the first film 910 is engaged with the third patterning roll 980, the second film 920 is engaged with the fourth patterning roll 990, and the tips of the teeth 981 of the third patterning roll 980 come into joining proximity with the tips of the teeth 991 of the fourth patterning roll 990, such that the troughs of the first film 910 become bonded to the troughs of the second film 920, to form the laminate with bonded protrusions 900a, which moves off of the rolls 980 and 990 in its finished form.

Although the assembly disclosed herein describe and illustrate solid state formation elements as rotating patterning rolls, in various embodiments, any such rolls may be replaced by one or more other kinds of solid state formation elements, such as planar patterning surfaces having similar protrusions, but which move into mating relationship and/or joining proximity with non-rotating movement (e.g. linear motion), as will be understood by one skilled in the art of solid state formation.

In particular, to produce thermoplastic bags with laminates having bonded protrusions, continuous webs of thermoplastic material may be processed through a high-speed manufacturing environment such as that illustrated in FIG. 11. In the illustrated process 1100, production may begin by unwinding a first continuous web or film 1180 of a first thermoplastic material from a roll 1104 and advancing the web along a machine direction 1106. The unwound web 1180 may have a width 1108 that may be perpendicular to the machine direction 1106, as measured between a first edge 1110 and an opposite second edge 1112. The unwound web 1180 may have an initial average thickness 1160 measured between a first surface 1116 and a second surface 1118. In other manufacturing environments, the web 1180 may be provided in other forms or even extruded directly from a thermoplastic forming process.

The process 1100 further can further involve unwinding a second continuous web or film 1182 of a second thermoplastic material from a roll 1102 and advancing the web along the machine direction 1106. The second film 1182 can comprise, a width, and/or a thickness that is similar or the same as the first film 1180. In alternative one or more implementations, one or more of the width, and/or thickness of the second film 1182 can differ from that of the first film 1180.

The first and second films 1180 and 1182 can be processed through an assembly 902, 902a, as described above in relation to FIGS. 9 and 10, to form a laminate with bonded deformations 900, 900a. Alternatively, additional material can be processed through an assembly 902, 902a, as described above in relation to FIGS. 9 and 10 to form laminates with bonded protrusions that are then bonded to the first and/or second film before they are folded as described below.

To provide sidewalls of the finished bag, the laminate with bonded deformations 900, 900a may be folded into a first half 1122 and an opposing second half 1124 about the machine direction 1106 by a folding operation 1120. When so folded, the first edge 1110 may be moved adjacent to the second edge 1112 of the laminate with bonded deformations 900, 900a. Accordingly, the width of the film(s) 1180, 1182 or laminate with bonded deformations 900, 900a proceeding in the machine direction 1106 after the folding operation 1120 may be a width 1128 that may be half the initial width 1108. As may be appreciated, the portion mid-width of the unwound film(s) 1180, 1182 may become the outer edge 1126 of the folded web. In any event, the hems may be formed along the adjacent first and second edges 1110, 1112 and a draw tape 1132 may be inserted during a hem and draw tape operation 1130.

To produce the finished bag, the processing equipment may further process the laminate with bonded deformations 900, 900a. For example, to form the parallel side edges of the finished bag, the laminate with bonded deformations 900, 900a may proceed through a sealing operation 1170 in which heat seals 1172 may be formed between the folded edge 1126 and the adjacent edges 1110, 1112. The heat seals may fuse together the halves 1122, 1124 of the folded laminate with bonded deformations 900, 900a. The heat seals 1172 may be spaced apart along the folded laminate with bonded deformations 900, 900a and in conjunction with the folded outer edge 1126 may define individual bags. The heat seals 1172 may be made with a heating device, such as, a heated knife. A perforating operation 1181 may for perforations 1182 in the heat seals 1172 with a perforating device, such as, a perforating knife so that individual bags 1190 may be separated from the laminate with bonded deformations 900, 900a. In one or more implementations, the laminate with bonded deformations 900, 900a may be folded one or more times before the folded film(s) 1180, 1182 may be directed through the perforating operation. The film(s) 1180, 1182 embodying the bags 1190 may be wound into a roll 1186 for packaging and distribution. For example, the roll 1186 may be placed in a box or a bag for sale to a customer.

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. Moreover, any combination of the above-described elements in all possible variations thereof is encompassed by the invention unless otherwise indicated herein or otherwise clearly contradicted by context. All changes that come within the meaning and range of equivalency of the claims are to be embraced within their scope.

We claim:

1. A thermoplastic bag, comprising:
first and second sidewalls of a thermoplastic film material;
a bottom edge connecting the first and second sidewalls; and
a closure mechanism for selectively closing an opening of the thermoplastic bag;
wherein one or more portions of the thermoplastic bag comprise a laminate with bonded protrusions, the laminate with bonded protrusions comprising a first thermoplastic film having a strainable network formed from a plurality of protrusions and protrusions of the strainable network of the first thermoplastic film are laminated to a second thermoplastic film.

2. The thermoplastic bag as recited in claim 1, wherein the plurality of protrusions comprise raised rib-like elements connected to troughs by stretched, transition regions, the stretched, transition regions being thinner than the rib-like elements and the troughs.

3. The thermoplastic bag as recited in claim 2, wherein the protrusions of the strainable network of the first thermoplastic film laminated to the second thermoplastic film comprise the raised rib-like elements of the strainable network.

4. The thermoplastic bag as recited in claim 2, wherein the protrusions of the strainable network of the first thermoplastic film laminated to the second thermoplastic film comprise the troughs of the strainable network.

5. The thermoplastic bag as recited in claim 1, wherein the one or more portions of the thermoplastic bag comprising the laminate with bonded protrusions comprise a drawtape positioned with in a hem of the first and second sidewalls.

6. The thermoplastic bag as recited in claim 1, wherein the one or more portions of the thermoplastic bag comprising the laminate with bonded protrusions comprise a region of each of the first and second sidewalls reinforced by bonding the laminate with bonded protrusions thereto.

7. The thermoplastic bag as recited in claim 6, wherein the region of each of the first and second sidewalls comprising the laminate with bonded protrusions comprises a hem of the thermoplastic bag.

8. The thermoplastic bag as recited in claim 6, wherein the region of each of the first and second sidewalls comprising the laminate with bonded protrusions comprises a bottom region of the thermoplastic bag.

9. The thermoplastic bag as recited in claim 6, wherein the region of each of the first and second sidewalls comprising the laminate with bonded protrusions comprises a region adjacent to a hem of the thermoplastic bag.

10. The thermoplastic bag as recited in claim 6, wherein one or more additional regions of the thermoplastic bag are devoid of strainable networks with bonded protrusions.

11. The thermoplastic bag as recited in claim 1, wherein the second thermoplastic film comprises a second strainable network formed from a second plurality of protrusions and protrusions of the second strainable network of the second thermoplastic film are laminated to the protrusions of the strainable network of the first thermoplastic film.

12. The thermoplastic bag as recited in claim 1, wherein the second thermoplastic film is devoid of strainable networks.

13. The thermoplastic bag as recited in claim 1, wherein the laminate with bonded protrusions comprises a third thermoplastic film bonded to the second thermoplastic film.

14. A thermoplastic bag, comprising:
first and second sidewalls;
a bottom edge connecting the first and second sidewalls;
a closure mechanism for selectively closing an opening of the thermoplastic bag; and
a laminate with bonded protrusions, the laminate with bonded protrusions comprising:
a first thermoplastic film incrementally bonded to a second thermoplastic film;
a first strainable network formed in the first thermoplastic film, the first stainable network comprising a first plurality of protrusions; and
a second strainable network formed in the second thermoplastic film, the second stainable network comprising a second plurality of protrusions;
wherein:
the second strainable network is configured and oriented as a mirrored version of the first strainable network; and
protrusions of the first plurality of protrusions are bonded to protrusions of the second plurality of protrusions.

15. The thermoplastic bag as recited in claim 14, wherein the closure mechanism comprises a drawtape, the drawtape comprising the laminate with bonded protrusions.

16. The thermoplastic bag as recited in claim 14, wherein the laminate with bonded protrusions is bonded to one or more regions of the thermoplastic bag.

17. The thermoplastic bag as recited in claim 14, wherein:
the first and second plurality of protrusions of the first and second strainable networks comprise raised rib-like elements connected to troughs by stretched, transition regions, the stretched, transition regions being thinner than the rib-like elements and the troughs;
the protrusions of the first and second plurality of protrusions bonded to each other comprise one of the rib-like elements or the troughs; and
the other of the rib-like elements or the troughs are separated from each other by a distance that provides the first and second sidewalls with an increased effective gauge.

18. The thermoplastic bag as recited in claim 14, wherein the bonded first and second strainable networks are positioned in a first region of the first and second sidewalls and a second region of the first and second sidewalls is devoid of the first and second strainable networks.

19. A method of forming thermoplastic bags with laminates having bonded protrusions comprising:
creating a first strainable network of protrusions in a first thermoplastic film by advancing the first thermoplastic film through a first pair of patterning rolls;
creating a second strainable network of protrusions in a second thermoplastic film by advancing the second thermoplastic film through a second pair of patterning rolls;
bonding protrusions of the first strainable network to protrusions of the second strainable network by advancing the first and second thermoplastic films together through a first patterning roller of the first pair of patterning rolls and a second patterning roller of the second pair of patterning rolls; and
forming the bonded first and second thermoplastic films into a bag.

20. The method as recited in claim 19, wherein forming the bonded first and second thermoplastic films into the bag comprises:
folding the bonded first and second thermoplastic films in half;
creating a hem in the first and second thermoplastic films; and
inserting a drawtape having a laminate with bonded protrusions into the hem.
